(19) United States
(12) Patent Application Publication
(10) Pub. No.: US 2026/0299970 A1
(43) Pub. Date: Oct. 1, 2026

(54) VIRTUAL WHITEBOARD PLATFORM HAVING ISSUE ATTRIBUTE ELEMENTS FOR ISSUE OBJECT MODIFICATION IN AN ISSUE TRACKING PLATFORM

(71) Applicant: Atlassian Pty Ltd., Sydney (AU)

(72) Inventors: Aditya Kishore, Sydney (AU); Xuanen Ouyang, Sydney (AU); Chris Joy, Sydney (AU); Emily Ditchfield, Sydney (AU); Eden Gorton, Sydney (AU); Abhinav Kishore, Sydney (AU)

(21) Appl. No.: 19/092,672

(22) Filed: Mar. 27, 2025

(51) Int. Cl. G06F 9/451

(52) U.S. Cl. CPC G06F 9/451

(57) ABSTRACT

Embodiments described herein relate to systems and methods for using a whiteboarding platform to update issue objects managed by an issue tracking platform. The system and methods can include causing display of an issue-based graphical object in the shared editor region of a whiteboarding platform. The system and methods can include causing display a set of attribute elements that can be applied to the shared editor region. The system and methods can include causing an attribute of the issue object to be updated at the issue tracking platform in response to a user input applying an attribute element to the issue-based graphical object and determining that that attribute element corresponds to an issue attribute element of the one or more issue attribute elements.

### TECHNICAL FIELD

Embodiments described herein relate to a virtual whiteboard platform. In particular, embodiments described herein refer to a virtual whiteboard platform having an interface for modifying issue objects within a separate issue tracking platform.

### BACKGROUND

Modern enterprises and collaboration platforms typically enable a group of users to collaborate with each other, for example, using electronic documents or other shared media. A virtual whiteboarding application may provide a virtual platform for groups of users to meet, brainstorm and collaborate on various ideas. Some traditional whiteboarding applications include the ability to plan projects and tasks, which must be formalized in separate project management or issue tracking systems. Porting data from a traditional whiteboarding application typically requires navigating to different applications and different graphical user interfaces, which may introduce errors and result in inefficient use of resources.

### SUMMARY

Embodiments described herein are directed to a computer implemented method for operating a whiteboarding platform to manage issue objects managed by an issue tracking platform. The methods can include causing display of a graphical user interface of the virtual whiteboarding platform using a platform frontend executing on a client device. The virtual whiteboarding platform can be configured to receive concurrent inputs from each of multiple client devices, each executing a respective platform frontend. The graphical user interface can include a shared editor region displayed on each respective graphical user interface of the respective platform frontend and be configured to generate graphical objects in response to inputs received from the multiple client devices. The method can include causing display of an issue-based graphical object in the shared editor region. The issue-based graphical object can display data extracted from an issue managed by the issue tracking platform and be a selectable graphical object configured to cause redirection to a corresponding issue view in a user interface of the issue tracking platform. The method can include causing display of an attribute graphical menu including a set of attribute elements that can be applied to the shared editor region. The set of attribute elements can include one or more issue attribute elements and each issue attribute element of the one or more issue attribute elements can be associated with an issue attribute of an issue object hosted by the issue tracking platform. The method can include causing the whiteboarding platform to access a gateway of the issue tracking platform and causing, via the gateway, a modification to the attribute of the issue object corresponding to the issue attribute element in response to a user input, positioning an attribute element, from the set of attribute elements, on the issue-based graphical object and determining that that attribute element corresponds to an issue attribute element of the one or more issue attribute elements. The method can also include causing the attribute element to be removed from the issue-based graphical object and causing display of an update of the issue-based graphical object displayed in shared editor region, the update indicating the modification to the attribute of the issue object on the issue tracking platform.

Embodiments are also directed to a computer implemented method for using a whiteboarding platform to update issue objects managed by an issue tracking platform. The method can include causing display of a graphical user interface of the virtual whiteboarding platform using a platform frontend executing on a client device. The virtual whiteboarding platform can be configured to receive concurrent inputs from each of multiple client devices, each executing a respective platform frontend. The graphical user interface can include a shared editor region displayed on each respective graphical user interface of the respective platform frontend and configured to generate graphical objects in response to inputs received from the multiple client devices. The method can include causing display of a first issue-based graphical object in the shared editor region. The first issue-based graphical object can display data extracted from a first issue object managed by the issue tracking platform and be a selectable graphical object configured to cause redirection to a corresponding issue view in a user interface of the issue tracking platform. The method can include causing display of a second issue-based graphical object in the shared editor region. The second issue-based graphical object can display data extracted from a second issue object managed by the issue tracking platform and be a selectable graphical object configured to cause redirection to a corresponding issue view in the user interface of the issue tracking platform. The method can include causing display of an attribute graphical menu comprising a set of attribute elements that can be applied to the shared editor region, the set of attribute elements comprising one or more issue attribute elements, each issue attribute element of the one or more issue attribute elements associated with an issue attribute that can be applied to an issue object at the issue tracking platform. The method can include causing the whiteboarding platform to access a gateway of the issue tracking platform and causing, via the gateway, a modification to an attribute of the first issue object and an attribute of the second issue object at the issue tracking platform in response to a user input applying an attribute element, from the set of attribute elements, to a sub-region comprising the first issue-based graphical object and the second issue-based graphical object.

Embodiments are further directed to a virtual whiteboard system operating on one or more servers. The virtual whiteboard system can include a platform backend operably coupled to a platform frontend operating on a client device. The platform backend can be configured to cause display of a graphical user interface of the virtual whiteboarding platform using a platform frontend executing on a client device. The virtual whiteboarding platform can be configured to receive concurrent inputs from each of multiple client devices, each executing a respective platform frontend. The graphical user interface can include a shared editor region displayed on each respective graphical user interface of the respective platform frontend and be configured to generate graphical objects in response to inputs received from the multiple client devices. The platform backend can be configured to cause display of an issue-based graphical object in the shared editor region. The issue-based graphical object can display data extracted from an issue object managed by the issue tracking platform and be a selectable graphical object to cause redirection to a corresponding issue view in a user interface of the issue tracking platform. The platform backend can be configured to cause display of a set of attribute elements that can be applied to the shared editor region. The set of attribute elements can include one or more issue attribute elements and each issue attribute element of the one or more issue attribute elements can be associated with an attribute that can be applied to an issue object at the issue tracking platform. The platform backend can be configured to cause the whiteboarding platform to access a gateway of the issue tracking platform and causing, via the gateway, a modification to an attribute of the issue object in response to a user input, positioning an attribute element, from the set of attribute elements, on the issue-based graphical object and determining that that attribute element corresponds to an issue attribute element of the one or more issue attribute elements.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a diagram of a system for implementing whiteboarding platform to update issue objects, as described herein.

FIG. 2 depicts an example process for using whiteboarding platform to update issue objects.

FIGS. 3A–3B depict an example virtual whiteboard graphical user interface used to display issue-based graphical objects and other graphical elements.

FIG. 4 depicts an example virtual whiteboard graphical user interface having an issue attribute element used to modify an issue element.

FIGS. 5A–5B depict an example virtual whiteboard graphical user interface having an issue attribute element used to modify an issue element.

FIGS. 6A–6B depict an example virtual whiteboard graphical user interface having an issue attribute element used to modify an issue element.

FIGS. 7A–7B depict an example virtual whiteboard graphical user interface having an issue attribute element applied to a sub-region within the interface.

FIG. 8 depicts an example virtual whiteboard graphical user interface having an issue attribute element applied to a dependency graphical element within the interface.

FIGS. 9A–9B depict an example virtual whiteboard graphical user interface having an issue attribute element used to split an issue into multiple issues.

FIG. 10 depicts an example graphical user interface of an issue tracking platform.

FIG. 11 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiment described herein are directed to systems and methods for using a whiteboarding platform to update or otherwise modify issues managed by an issue tracking platform. In particular, the whiteboarding platform includes a user interface and integration which allows users to update or modify issues in a separate issue tracking platform using graphical objects (e.g., attribute elements or “stamps”) that are displayed in the whiteboard graphical user interface. The whiteboarding platform can be configured to create and/or display issue-based graphical objects, which may be selectable graphical objects that are linked to issues managed by an issue tracking platform. For example, the issue-based graphical objects may display issue information based on issue data received from the issue tracking platform and/or be selectable to cause display of issue data at the issue tracking platform. The whiteboarding platform may be configured with a variety of issue attribute elements, which may be applied to issue-based graphical objects displayed in the whiteboard user interface and cause an action to be performed with respect to a corresponding issue at the issue tracking platform.

A whiteboarding application, such as described herein, may allow users to interact and contribute ideas in a digital editor region (also referred to herein as a “shared editor region”). For example, users may add handwritten notes, sticky notes, doodles, and many other visual graphics that convey ideas, capture action items, brainstorm solutions, and so on. Unlike many traditional digital files, users can contribute to the canvas contemporaneously, which improves virtual collaboration during a multi-user whiteboarding session. The virtual canvas also allows users to move and/or shift content within the digital canvas without having to erase work or generate multiple pages or documents. Similarly, collaborative sessions in whiteboarding platforms can be saved for later reference.

Unlike the whiteboarding platform described herein, many traditional collaboration tools lack integrations to separate platforms. For example, in many collaborative sessions, action items or tasks are captured as free-form notes or text. To implement these action items or tasks, users often need to manually note tasks and transcribe them onto the appropriate platforms and/or capture accordingly in an email or in a document. As a result of this manual transcribing process, some action items may be lost in the process. Also, in some cases, users may need to toggle between the collaboration tool and tracking platforms to transcribe notes, which requires multiple instantiations of different applications. Typically, this requires additional computing resources and may also require the user to manually switch between platforms, also referred to as “context switching,” which can be an inefficient way to operate a user interface. Many times, actions may not be captured at all because of this tedious task—causing frustration for users and potentially lost data. Similarly, follow up meetings may be needed to recapture action items that were not logged and/or formalized.

Unlike traditional editing software, the whiteboarding platform described herein can be configured with graphical objects (e.g., issue attribute elements or stamps) that can be configured to cause updates or other changes to issue objects (also referred to herein as “issues”) managed by an issue tracking platform. For example, the whiteboarding application can be configured to allow a user to apply an issue attribute element to one or more issue-based graphical objects displayed in the whiteboard interface (e.g., using drag-and-drop type inputs, or “stamping” style inputs as described herein). As a result, the whiteboarding platform can be configured to cause the issue tracking platform to update or otherwise modify the corresponding issue object (e.g., update issue attributes for the issue object). For example, issue attribute elements may be configured to assign a particular user to an issue, update a status or priority of an issue, assign resource estimations to an issue, define dependencies between issues, split issues, and so on. Accordingly, users working in a virtual whiteboard environment may collaborate to define, change, or otherwise modify issues and/or interrelations between issues without needing to separately access or view the issues in the issue tracking platform.

In some cases, the issue attribute elements may be referred to as stamps, attribute stamps, virtual stickers and/or attribute stickers. The stamps/stickers may be displayed as graphical elements that can be placed in the shared editor region. The attribute elements (stamps/stickers) described herein can be different from typical graphical stickers which function as purely visual elements. For example, the attribute elements (stamps/stickers) described herein can be configured to cause updates/modifications to an issue object hosted by an issue tracking platform. Accordingly, the attribute elements described herein may be functionally configured graphical elements and the application of these attribute element to specific objects – such as an issue-based graphical object – can cause an action at different platform such as causing changes to issue objects managed by an issue tracking platform.

The user interface examples described herein can include adaptive functionality that facilitates the interface between the whiteboarding application and other platforms. The whiteboard may also include compressed menus that makes it easier for users to quickly change the look of graphical objects. The whiteboarding platform has a shared editor region which allows for shared editing capabilities. For example, multiple users can concurrently edit, add graphical objects, delete items, move items, and so on. As described herein, the shared editor region is a virtual canvas that can be expanded in any direction within the 2D plane of the canvas. For example, the editor region or canvas extends as users add more content. Because the canvas region is unstructured, it allows graphical objects and/or any other content to be placed anywhere within the region. In other words, the canvas region allows users to place content without grid restrictions, margins, or size limitations (e.g., freeform). As a result of this configuration, during a video conference, team members may concurrently collaborate (e.g., on a project) similar to collaboration using whiteboards in traditional physical meeting rooms.

Unlike some traditional collaboration tools, the whiteboarding platform described here can communicate (e.g., using a gateway and/or application programming interface call or endpoint) to other platforms, such as a gateway of an issue tracking platform, a content collaboration platform, or other third-party platforms. By communicating with an issue tracking platform (e.g., via gateway), for example, users can track action items, update issues, and capture important items from a whiteboard session.

Each of the actions exemplified above may include application programming interface (API) calls or other data requests to a remote host. The host may return content data and/or issue data from the issue tracking platform to the virtual whiteboard. The issue status may be updated in the graphical user interface of the virtual whiteboard platform. For example, a completed issue-based graphical object may change colors subsequent to an update from the issue tracking platform. An issue object requiring immediate attention may be highlighted such that the users interfacing the whiteboard can be aware of changes in other platforms. In this example, the share editor region may have a set of visual cues that facilitate collaboration.

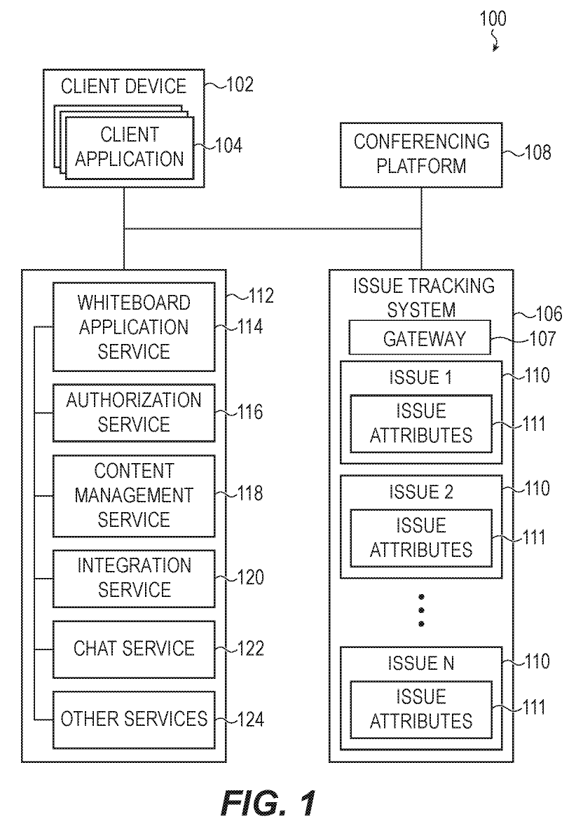

These foregoing and other embodiments are discussed below with reference to FIGS. 1–11. The detailed description given herein with respect to these figures is for explanation only and should not be construed as limiting.

FIG. 1 depicts a diagram of a virtual whiteboard system 100, as described herein. The system 100 is depicted as implemented in a client-server architecture or client-service architecture, but it may be appreciated that this is merely one example and that other communications architectures are possible. In accordance with the examples provided herein, the system 100 of FIG. 1 can be used for collaboration among a group of users using a virtual whiteboard graphical user interface and executing an action with respect to an external platform, such as a videoconferencing application, an issue tracking platform, a content management system, and so on, via a computer network. All or portions of the system 100 may be referred to as virtual whiteboard system, whiteboard system or system, as used herein.

An architecture of the system 100 may allow participant users of a whiteboarding session to share their ideas with other users, create one or more actions to be performed with respect to an issue being managed by an issue tracking platform or a content item being managed by a content management system, and automatically cause execution of one or more actions with respect to the issue tracking platform and/or the content management system. By way of a non-limiting example, an automatic execution of the one or more actions with respect to the issue tracking platform and/or the content management system is performed as a participant user drags or otherwise positions a graphical object on a virtual canvas where the graphical object is currently placed by the participant user into or on an automation or shared editor region, which may be a user-defined action region, of the virtual whiteboard graphical user interface displayed on the participant user’s client device.

The networked computer system or the content collaboration system of FIG. 1 depicts an example configuration in which multiple client devices 102 may access a host server 112 of a set of host servers via a computer network. The host server 112 may be referred herein as a whiteboard platform server 112. The computer network may include a distributed network which may include local networks, gateways, and networking services provided by one or more internet service providers. For example, the issue tracking system 106 may include a gateway 107 that is used to facilitate communications with the host server 112 and/or client device 102.

The client devices 102 are able to collaborate with each other and other users using a conferencing platform 108, and the whiteboard platform server 112 provides a whiteboarding application service 114. In the present example, the conferencing platform 108 is depicted as being separate from the platform server 112, in some instances, some or all of the services of the conferencing platform may be integrated with or provided by a service operating on the platform server 112.

In general, the conferencing platform 108 may provide audio, video, and/or audiovisual conferencing services. The conferencing platform 108 may also be used to share a single instance of a whiteboard application being executed on a client device as a frontend of the application in conjunction with the backend provided by the whiteboarding application service 114. The conferencing platform 108 may share a single instance of the whiteboard application, while the backend whiteboarding application service 114 concurrently provides the same whiteboard session to multiple client devices. As a result, the participants in a videoconference or telephone conference provided by the conferencing platform 108 may be the same (or have participants in common) with participants of a whiteboarding session.

The whiteboarding application service 114 may display a virtual board or virtual canvas in a virtual whiteboard graphical user interface displayed on a display of each of the client devices 102, and a participant user can collaborate using the whiteboarding application service 114 via the network either directly or through the other services by the platform server 112. Additionally, or alternatively, the whiteboarding application service 114 may allow or enable a user of a client device 102 to work individually and perform actions with respect to one or more external platforms, as described herein.

The collaboration platform server 112 of the set of host servers may include multiple platform services, which may be part of the system 100. For example, the multiple platform services may include, but not limited to, an authorization service 116, a content management service 118, an issue tracking service 120, a chat service 122, and other services 124, and so on. A platform service of the multiple platform services may be implemented as one or more instances of the platform service executing on one or more host servers of the set of host servers.

The multiple platform services may provide different services including, for example, issue integration services for creating, managing, updating, and tracking issues for software development, bug tracking, content management services for creating, managing, and searching content items, and/or information technology service management (ITSM) services at an issue tracking platform. Also, while the various platform services 116, 118, 120 122, 124, and so on, are all depicted as being provided by the same server 112 or set of servers, each of the platforms may be implemented on a separate server that is distinct from the server 112. Depending on the implementation and the platform provider, the various platforms 116, 118, 120, 122, 124, and so on, may be provided by a third party and may be referred to as third-party platforms.

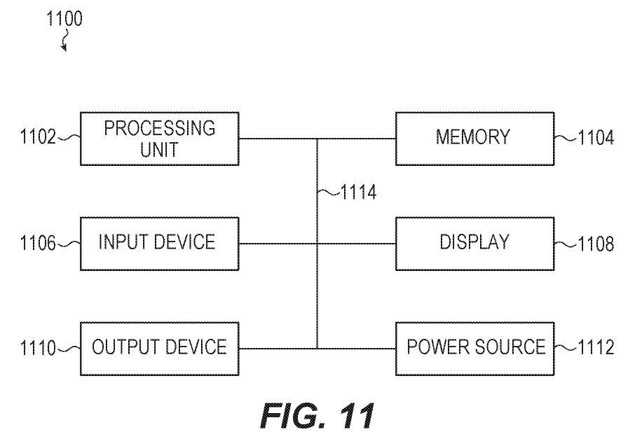

The client devices 102 execute or operate respective example client applications 104, which may include a dedicated client-side application or may be a web browser client application. The client applications 104 may also be referred to herein as frontend applications and may provide one or more graphical user interfaces, for example, virtual whiteboard graphical user interfaces, for interfacing with the backend applications or services provided by the host server 112. The client devices 102 typically include at least one display, at least one processing unit, at least one computer memory, and other hardware components. An example device including hardware elements is described below with respect to FIG. 11.

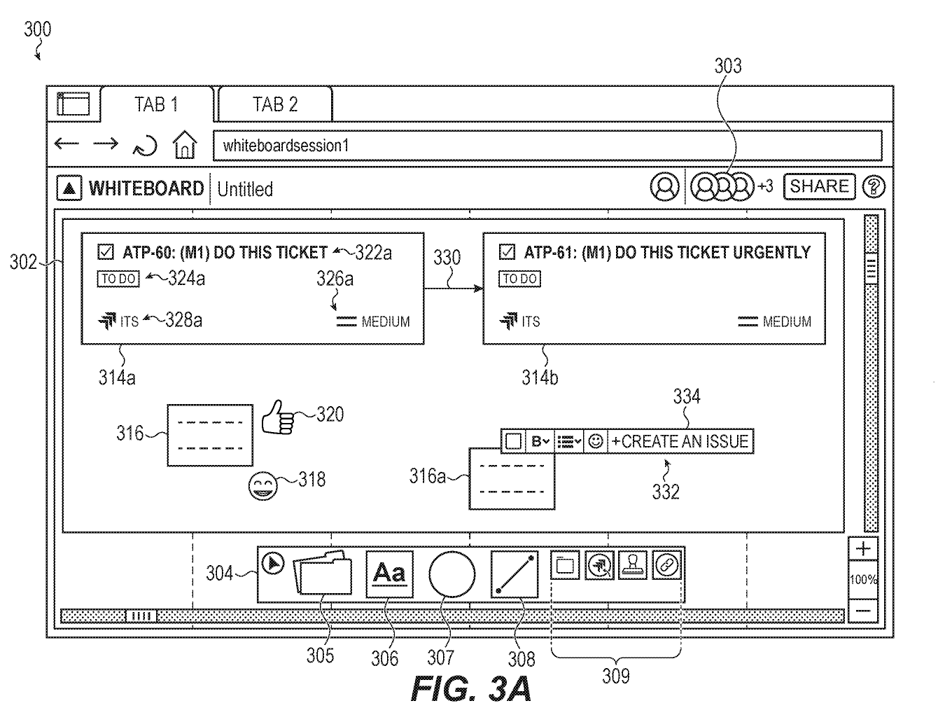

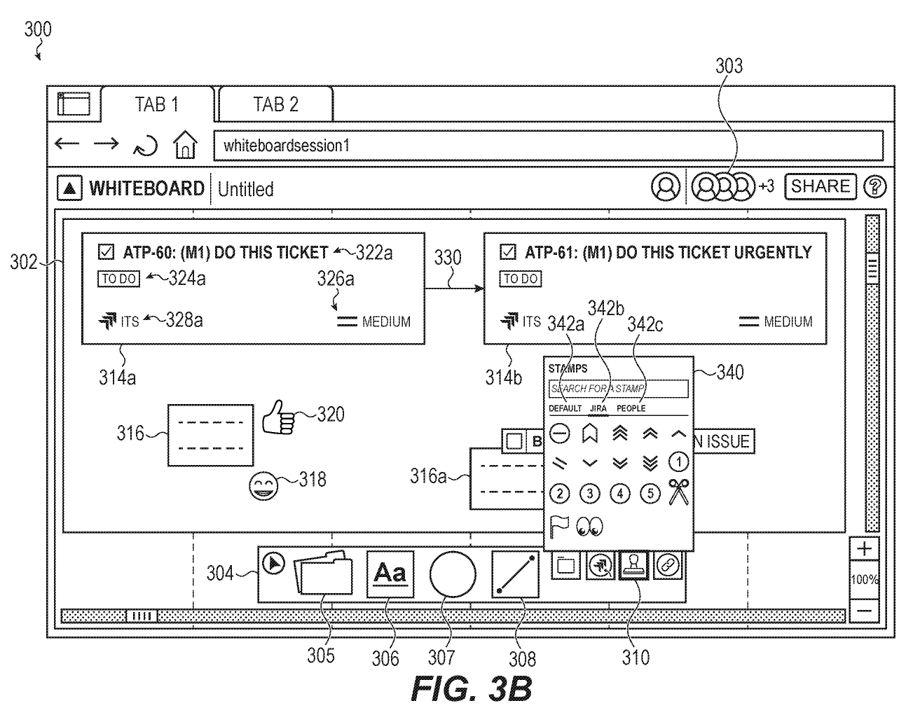

The frontend applications 104 executing on the client devices 102, may also be referenced herein as a whiteboard application, whiteboard frontend or a whiteboarding application instance, and may display a virtual whiteboard graphical user interface (or a graphical user interface of a whiteboarding application instance) according to example views shown in FIGS. 3–10, as discussed below. A participant user can create a graphical object (also referred herein as a user-defined graphical object), having properties, for example, a text and/or an icon, on the virtual whiteboard graphical user interface using the whiteboarding application service 114 during a whiteboarding session. Each graphical object may further have properties including a shape, a size, and/or a color in which the graphical object is displayed on the virtual whiteboard graphical user interface on the client devices 102. The properties of the graphical object may be visible properties to participant users of the whiteboarding session in accordance with a permission granted to each participant user based on their respective user profile.

The whiteboarding application service 114 may provide an interface to client devices 102 to the one or more backend applications, and/or software platforms, such as a content management system or an issue tracking platform during collaboration with other users during a whiteboarding session or working individually to perform an automation with respect to one or more external platforms, as described herein. The client devices 102, and 104 may be executing a frontend application that consumes services provided by the whiteboarding application service 114 during the whiteboarding session. By way of a non-limiting example, the interface provided by the whiteboarding application service 114 may be webservice based, such as a Representational State Transfer (REST) webservice. The electronic documents, pages, or electronic content may be transferred between a client device and a host server using one or more of JavaScript Graphical object Notation (JSON), Extensible Markup Language (XML), Hypertext Markup Language (HTML), and/or a proprietary document format. Additionally, or alternatively, the interface provided by the whiteboarding application service 114 may be as a plugin of a web browser or a web extension of a web browser.

In some embodiments, a user may be admitted to a whiteboarding session, or the user may be permitted to perform an automation with respect to one or more external platforms, based on authentication and/or authorization of a user using the authorization service 116. The authorization service 116 may authenticate a user based on user credentials, which may include a username or other user identification, password or pin, biometric data, or other user-identifying information. The user credentials may be stored and tracked using a token, an authentication cookie, or other similar data element. Upon successful authentication/authorization of a user, the whiteboarding application service 114 may retrieve a user profile associated with an authenticated user of a client device. The user profile associated with the user may suggest various permissions of a user for creating, editing, accessing, searching, and/or viewing various electronic documents, pages, electronic content, issues, tickets on the content management system and/or the issue tracking platform. The user profile associated with the user may also identify other details of the user, including but not limited to, a role of a user in an organization, a role of the user during the whiteboarding session, one or more groups to which a user is a member, other users of the one or more groups to which the user is a member, one or more projects related to the user, one or more issues or tickets (managed by the issue tracking platform) the user is assigned to, and so on. The user profile may include, but not limited to, user permission settings or profiles, and user history that may include user logs or event histories, system settings, administrator profile settings, content space settings, and other system profile data associated with the backend applications described herein and associated with the user. The user profile may also include user permission settings or profiles corresponding to performing an automation with respect to one or more external platforms. Accordingly, the user of the client device may participate and perform various actions including an automation with respect to the issue tracking platform and/or the content management system based on the retrieved user profile. The other services 118 described herein may provide a user interface to other applications or services, for example, an audio and/or a video recording of the whiteboarding session.

While the whiteboarding application service 114 is configured to enable collaboration among participant users on a virtual whiteboard displayed as a virtual whiteboard graphical user interface on a display of each client device, the chat service 122 may provide other services related to a chat interface or a messaging interface during the whiteboarding session.

The content management service 118 may be a plug-in, a module, a library, an API, and/or a microservice providing interface to a content management system (not shown) managing content items. Alternatively, the content management service 118 may manage content items for the system 100. Using the interface provided by the content management service 118, one or more content items managed by the content management system may be updated, edited, deleted, viewed, and/or searched as described herein in accordance with the parsed text and/or icons of graphical objects, and/or in accordance with an action configured for an action region, as described herein. A new content item or a template for a new content item may also be created on the content management system using the interface provided by the content management service 118. Thereby, a participant user is not required to launch an instance of the content management system web browser application separately to perform operations with respect to one or more content items managed by the content management system during a whiteboarding session. In some cases, the content management service 118 may be a documentation or wiki service that provides documents or pages of a document space or page space. The pages or documents may include user-generated content used to document projects, products, or services for an organization. In some cases, the pages or documents are implemented as part of an information technology service management (ITSM) system for providing documentation for solving user issues or technical problems.

The issue integration service 120 may be a plug-in, a module, a library, an API, and/or a microservice providing an interface to an issue tracking platform 106 managing issues or tickets. Using the interface provided by the issue integration service 120, one or more issues managed by the issue tracking platform 106 may be updated, edited, deleted, viewed, and/or searched as described herein in accordance with the parsed text and/or icons of graphical objects, and/or in accordance with an action configured for an action region, as described herein. A new issue or a template for a new issue may also be created on the issue tracking platform 106 using the interface provided by the issue integration service 120. Thereby, a participant user may not be required to launch an instance of the issue tracking platform web browser application separately to perform operations with respect to one or more issues managed by the issue tracking platform during a whiteboarding session. By way of a non-limiting example, any service described herein may be a plug-in, a module, a library, an API, and/or a microservice providing a respective interface. The issue integration service 120 may also be operated as part of an ITSM system used to track tickets or technical issues raised by users or clients.

In some cases, the issue integration service 120 can be configured to determine if an authenticated user participating in a whiteboarding session has a corresponding account at the issue tracking platform. In some cases, the issue integration service may determine whether the corresponding account is authenticated at the issue tracking platform and/or cause the corresponding account to be authenticated with respect to the issue tracking platform. The issue integration service 120 can be configured to generate API calls to the issue tracking platform based on actions performed at the whiteboard platform and/or receive API calls or other updates from the issue tracking platform and cause the whiteboard platform to be updated in accordance with received updates. For example, updates from the issue tracking platform may include changes to an issue object based on an action performed at the whiteboarding platform and/or the issue tracking platform, confirmations of changes to an issue object based on actions performed at the whiteboard application, refreshing content at the whiteboard application, and so on.

The issue tracking platform 106 can be configured to generate and manage issues 110 to assist with a problem or other tasks. An issue 110 can be associated with issue attribute 111 (which also may be referred to as issue data), which may include a variety of information including a request type, an issue title, a summary of the issue input by a requesting user, and/or other information that is associated with an issue 110. The issue tracking platform 106 (e.g., using issue attributes 111) may also associate other types of data with the issue, which may include workflow data. The workflow data may define a series of states that the issue 110 or task must traverse before being completed. In some implementations, the issue 110 is automatically processed in accordance with the states defined in the workflow, as tasks are completed, or state criteria are satisfied. The system may also track user interaction events (e.g., messages), issue state transitions, automations associated with the issue and other events that occur over the lifecycle of the issue, which may be indexed and searchable by the system. In some implementations, the issue is automatically processed in accordance with the states defined in the workflow, as tasks are completed, or state criteria are satisfied.

In some cases, the issue tracking platform 106 may define projects, which can be used to manage and organize a group of interrelated issues 110. For example, a project may be a data type (e.g., a container data structure) within the issue tracking platform 106 used to organize and track a collection of issues 110 related to a specific team, product, or service. A project can allow a team to manage their work by assigning tasks and/or issues 110, following workflows, and monitoring progress for a set of related issues.

Typically, issue attributes 111, and/or other issue data is defined for a given issue when the issue is created at the issue tracking platform. An issue may include issue attributes 111 that define relationships to other issues. For example, a particular issue may be dependent on completion of one or more other issues. In this example, work, automations or other tasks for the particular issue may not be initiated until completion of the one or more other issues. If a project has additional issues that depend on the particular issue, these issues all need to be created at the issue tracking platform. For large complex projects this may require creating large numbers of inter-dependent issues, prior to the initiation of the project and/or many of the issues defining the project. Accordingly, if one issue is changed (e.g., removed), all the issues that depend on the changed issue may need to be modified. Further some actions at an issue tracking platform rely on cross-project collaboration and data sharing. Since projects are typically organized around a specific team, configuring cross-project permissions and data sharing between projects can greatly increase the complexity of configuring issues to share data, increase the complexity of coordinating issues across different projects and teams, and so on.

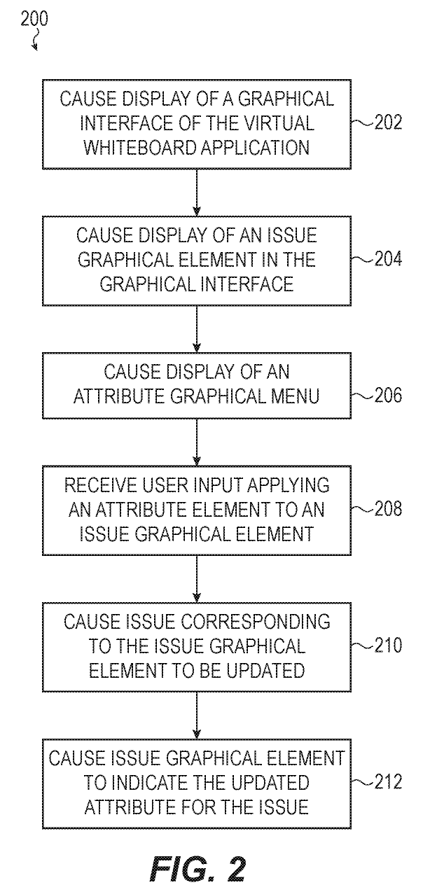

FIG. 2 depicts an example process 200 for using whiteboarding platform to update issue objects. The process 200 can be performed by the systems described herein including system 100.

At operation 202, the process 200 can include causing display of a graphical interface of a whiteboarding platform. The system can cause multiple instances of the graphical interface to be displayed on multiple client device. Each graphical interface displayed on a respective client device may allow a user of the client device to provide inputs to the whiteboarding platform and view changes made by other users using a different client device hosting a separate instance of the graphical interface. The whiteboarding platform can be configured to receive simultaneous inputs from each of the client devices and update each instance of the graphical interface in response to the received inputs.

The graphical user interface can include a shared editor region that is displayed on each of the client devices. The shared editor region can allow for shared editing capabilities. For example, multiple users can concurrently edit, add graphical objects, delete items, move items, and so on. The shared editor region may allow graphical objects and/or any other content to be placed anywhere within the region. In other words, the shared editor region allows users to place content without grid restrictions, margins, or size limitations (e.g., freeform). Participants to a whiteboarding session may create graphical objects, which may be referred herein as user-defined graphical objects including user-generated content. For example, the user-defined graphical objects may include or be similar to sticky notes, a participant user may generate and place a user-defined graphical object on the virtual whiteboard graphical user interface in a virtual shared editor region.

Each user may interact with the canvas region using a client device that displays a virtual whiteboard graphical user interface (GUI). The virtual whiteboard GUI one each client device may display a portion of the shared editor region along with other virtual tools which may be used to navigate and/or interact with the canvas by generating and editing virtual objects. Accordingly, different client devices may simultaneously display and interact with different portions of the shared editor region.

At operation 204, the process 200 can include causing display of an issue-based graphical object in the graphical interface. The issue graphical object can be displayed in an editor region of the whiteboarding platform. The issue graphical object can be a graphical object displayed in the shared editor region and is populated with information retrieved from or received from the issue tracking platform. For example, each issue graphical object can link to an issue object managed by the issue tracking platform (e.g., using a network path or other object identifier to retrieve/receive data related to the linked object). The issue graphical object can display data (including metadata) extracted from the corresponding issue object at the issue tracking platform. In some cases, the displayed data can correspond to attributes of an issue object. In some cases, an issue graphical object can also display embedded content, which may include content that is configured by the user at the whiteboard platform.

The issue-based graphical object can be selectable (e.g., a graphical selectable link with embedded content) that directs the user to the issue tracking platform. In some cases, the issue-based graphical object can be a text box, or any other suitable graphical object, which is displayed in the shared editor region and is associated with (e.g., linked to) an issue managed by the issue tracking platform. In some cases, the issue-based graphical object can be converted from a native object that is created using the shared editor region such a text box, sticky note and so on. For example, in response to determining that the native object corresponds to an issue, the whiteboarding platform may replace the original native object (e.g., the virtual sticky note) with an issue-based graphical object or other similar graphical element designating the object as an issue connected/associated object.

In some cases, the issue-based graphical object can be displayed as an issue card with summarized information of the issue. In other cases, the issue-based graphical object can be displayed as a native graphical object (e.g., as a sticky note or as the initial graphical object), and so on. Regardless of the view of the issue-based graphical object, the issue-based graphical object can include a link that directs the user to the issue tracking platform to view the issue.

While the selectable graphical objects corresponding to an issue are concurrently displayed to users in the whiteboarding interface, the metadata and/or issue content/attributes displayed may depend on a particular user’s permission profile with respect to the issue tracking platform or the issue content. For example, users that do not have the appropriate permissions credentials may not be displayed any data from the issue (e.g., display of the issue content may be suppressed). In other examples, issue content/attributes may be displayed in accordance with the permissions profile of a user. For example, certain users with administrative privileges may be displayed additional issue information compared to other users. In some embodiments, when a user selects the selectable issue-based graphical object, an edit option may be displayed. The whiteboard frontend application may display an editable window and, in accordance with a user modifying at least one field, an API call may be generated to edit the issue at the issue tracking platform.

At operation 206, the process 200 can include causing display of an attribute graphical menu. The whiteboard interface can include fixed user menus, quick access menu or primitive bar, and active user elements. In some cases, the attribute graphical menu can be integrated into one or more of the displayed menus. The attribute graphical menu can be configured with attribute elements which a user may select and place in the shared editor region. The attribute graphical menu can include attribute graphical elements that are configured to be applied to an issue-based graphical object and cause one or more actions related to the issue to be performed. For example, an attribute graphical element may be used to assign a user to the issue, update a status/priority of an issue, apply an estimated resource requirement for the issue and so on. Applying an attribute graphical element can cause the issue to be updated at the issue tracking platform.

In some cases, the whiteboard includes a primitive bar (e.g., a quick access menu). The primitive bar includes an array of primitive objects which users may select to place to generate graphical objects. Each primitive object of the primitive bar may include a primitive indicator that shows the user a format or shape of the objects to be selected. In some embodiments, primitive objects include sub-types (e.g., different line shapes, different line thickness, different shapes). In response to a user selection of a primitive object with multiple sub-types, a sub-menu may be displayed configured to allow the user to quickly select different primitive sub-types. A selection of a sub-type causes an update of the primitive indicator and causes the primitive to be rendered (at a similar dimension or near-similar dimension as the graphical object to be created, for example). In some cases, the compressed user menu is also updated to display the primitive sub-type selected. In some examples, the user may select a primitive sub-type and modify the sub-type in the compressed user menu, causing the key indicator and the primitive indicator to be updated concurrently. The user selection of a primitive sub-type (e.g., a format option) saves the user selection. Subsequent selections by the user of the same primitive object, adopts the prior formatting option.

At operation 208, the process 200 can include receiving a user input applying an attribute element to an issue-based graphical object. For example, a user may select an attribute element from an attribute element graphical element and apply the attribute element to an issue-based graphical object displayed int eh shared editor region. In some cases, the attribute element may be applied using a drag-and-drop operation, however, other suitable inputs can be used to apply the attribute element to an issue-based graphical object.

At operation 210, the process 200 can include causing the issue, corresponding to the issue-based graphical object, to be updated at the issue tracking platform. An attribute graphical menu can include a set of issue attribute elements which are each associated with an issue attribute that can be applied to the issues/ used to update the issue. For example, a first issue attribute element may be configured to cause a particular user to be assigned to the issue. In some cases, the attribute graphical menu can include multiple issue attribute elements each associated with a different user account and configured to cause the respective user to be assigned to the issue. Accordingly, applying one or more of these issue attribute elements to an issue-based graphical object causes the respect user account to be assigned to the issue. In other cases, one or more issue attribute elements can be configured to change a status/priority of an issue, apply an estimated resource requirement, and/or perform other functions for attributes of the issue.

The issue attribute elements may each be configured to cause communication process between the whiteboard platform and the issue tracking platform to cause a modification to an issue object and a corresponding update to an issue-based graphical object displayed in the whiteboarding platform interface. For example, in response to an issue attribute element being applied to an issue-based graphical object, the whiteboard application may generate an API call (or other similar communication) to the issue tracking platform. The API call may include an updated request or modification request corresponding to a function of the issue attribute element. For example, if the issue attribute element is configured to modify a priority of an issue object, the API call may include a priority change request. Additionally, the whiteboarding platform may be configured to determine an issue identifier associated with the issue-based graphical object and include that issue identifier in the API. In some cases, the API call may include a user identifier for a user account associated with the input that applied the issue attribute element to the issue-based graphical object and/or other suitable information that is used to cause the update at the issue tracking platform. For example, a user identifier may be used to determine whether a particular user account has permissions to perform the requested action at the issue tracking platform.

In some cases, an attribute menu may include other types of attribute elements (which also may be referred to as primitive objects) in addition to issue attribute elements. For example, the attribute menu may attribute elements such as include note objects (e.g., virtual sticky notes), graphical objects that may be a shape, and graphical object that may be a text box. Similarly, the attribute menu may include attribute elements such as emojis, stamps, and voting buttons (which may be referred to as “indicator attribute elements”). The indicator attribute elements may be visual elements that do not have another other associated function other than as a graphical element. In some cases, indicator attribute elements may cause some function/action to be performed at the whiteboarding platform. For example, voting buttons applied to a particular region may be detected and analyzed by the whiteboarding platform to determine a vote tally/result, and update objects based on the determined result. The indicator attribute elements may be applied to issue-based graphical objects but may not be configured to cause any action at the issue tracking platform. For example, indicator attribute elements applied to issue-based graphical objects may only cause actions to be performed at the whiteboarding platform and/or at some other system such as a document management system.

At operation 212, the process 200 can include causing the issue-based graphical object to indicate the updated attribute for the issue and in response to an issue attribute element being applied to the issue-based graphical object. The issue-based graphical objects displayed in the shared editor region can include status indicators, which may be a graphical indicator displayed in conjunction with an issue-based graphical object (e.g., text, colors, graphics, animations, and so on). In response to an issue attribute element being applied to an issue-based graphical object and/or the issue tracking platform causing an update to the issue object, the whiteboarding platform can display/update a status indicator for an issue-based graphical object. For example, in response to a particular user being assigned to an issue, the whiteboarding platform may display a graphic (e.g., a particular user avatar) within the issue-based graphical object, indicating that the particular user account associated with the graphic has been assigned to the issue. The status elements may function as a way to display attribute information for an issue and/or provide a confirmation that an issue has been updated in accordance with an applied issue attribute element applied to a corresponding issue-based graphical object.

In some cases, the issue-based graphical object can be configured to display a predefined set of status fields or issue data that is received from the issue tracking platform and corresponds to attributes for a respective issue object. Accordingly, as the issue object is updated at the issue tracking platform, the information displayed in the issue-based graphical object can also be updated. In some cases, the issue-based graphical object may be configured to display an information related to a subset of attributes for a corresponding issue object. Accordingly, if issue attributes corresponding to displayed information at the issue-based graphical object are updated for the issue object, the issue-based graphical object can be updated to reflect these changes. In some cases, issue attributes for an issue object may be updated and may not correspond to displayed data at the issue-based graphical object. In these cases, changes to an issue object may not cause changes to the issue-based graphical object. Accordingly, applying an issue attribute element to an issue-based graphical element may cause the corresponding issue object to be updated, which in turn cause the information displayed in the issue-based graphical object to be updated. However, in some cases, an attribute element may cause an issue object to be updated, but the updated attribute may not be part of the information displayed in a correspond issue-based graphical object. Accordingly, in these cases, the issue attribute may cause the issue object to be updated but not cause changes to the issue-based graphical object.

Additionally or alternatively, the whiteboard application can be configured to dynamically display the issue attribute graphical objects to provide visual indicators of whether the corresponding issue object was modified. For example, a user input may apply an issue attribute element to an issue-based graphical object – for example using a cursor move operation such as a drag-and-drop operation. In response to completion of the user input, the issue attribute element may be temporarily displayed over (or in conjunction with) the issue-based graphical element. In response, to receiving a confirmation from the issue tracking platform that the issue object was updated, the whiteboard application can be configured to remove the graphical object for the issue attribute element from the issue-based graphical object. In some cases, the whiteboarding platform may also cause the displayed information in the issue-based graphical object to be updated, as described herein.

FIG. 3A depicts an example virtual whiteboard graphical user interface 300 that can be used to display issue-based graphical objects and other graphical elements. The graphical user interfaces (GUI) 300 of the whiteboard (e.g., such as whiteboarding platform 114) can be used to create an issue in the issue tracking platform (e.g., such as issue tracking platform 106). As depicted in the figures, a virtual whiteboard platform may include a user interface that can import and export content items from the issue tracking platform, generate suggestions for issue fields (e.g., issue type, project, and so on), and create issues in the issue tracking platform.

As shown in FIG. 3A, a whiteboard interface 300 has a shared editor region 302. The shared editor region 302 allows users to freely add, delete, and edit graphical objects, handwrite, draw, and so on, as described hereon. The shared editor region 302 can be accessed by multiple users concurrently (e.g., in real time). In some embodiments, the shared editor region 302 takes up a significant space of the interface in order to provide users a broad view of the region. As a result of this configuration, the whiteboard interface 300 may include fixed user menus, quick access menu or primitive bar 304, and active user elements 303.

In some embodiments, and by way of a non-limiting example, properties of each graphical object may uniquely identify a participant user who created the graphical object. Additionally, or alternatively, the properties of the graphical object may uniquely identify whether the graphical object corresponds to a graphical object associated with an issue managed by an issue tracking platform, or a graphical object associated with a content item managed by a content management system.

Due to the collaborative nature of the whiteboard, the user interface 300 includes features that allow users to see who is collaborating on the shared editor region 302. For example, the active user elements 303 displays the number of users actively on the whiteboard (e.g., viewing, editing, adding, and so on). The active user elements 303 may be displayed as a side panel, a top panel, and so on, and may include a summary of the users (e.g., number of users within the platform). In some embodiments, the active user menu may display pictures, avatars, or any other identifying information. While users are actively on the platform, the cursor of each user may be displayed in the canvas. The cursors may include the name of the user. In some embodiments, the cursor includes pictures, avatars, or different colors to differentiate users. A user may click on the identifying information (e.g., over the cursor or over the active user elements 203) of a user to start a chat or to retrieve that user’s profile.

The quick access menu or primitive bar 304 is configured to provide the user quick access to graphical objects/elements, menus, and/or access to other tools that can be used to edit, modify, or otherwise interact with elements/objects displayed in the shared editor region 302. For example, a user may select one or more native primitives from the quick access menu or primitive bar including, without limitation, sticky notes 305, text boxes 306, shapes 307, lines 308, function menu 309. The primitives from the primitive bar 304 can be used to place graphical objects in the shared editor region 302, modify graphical objects, and/or perform other actions at the whiteboarding platform, and/or at other systems (e.g., an issue tracking platform), as described herein.

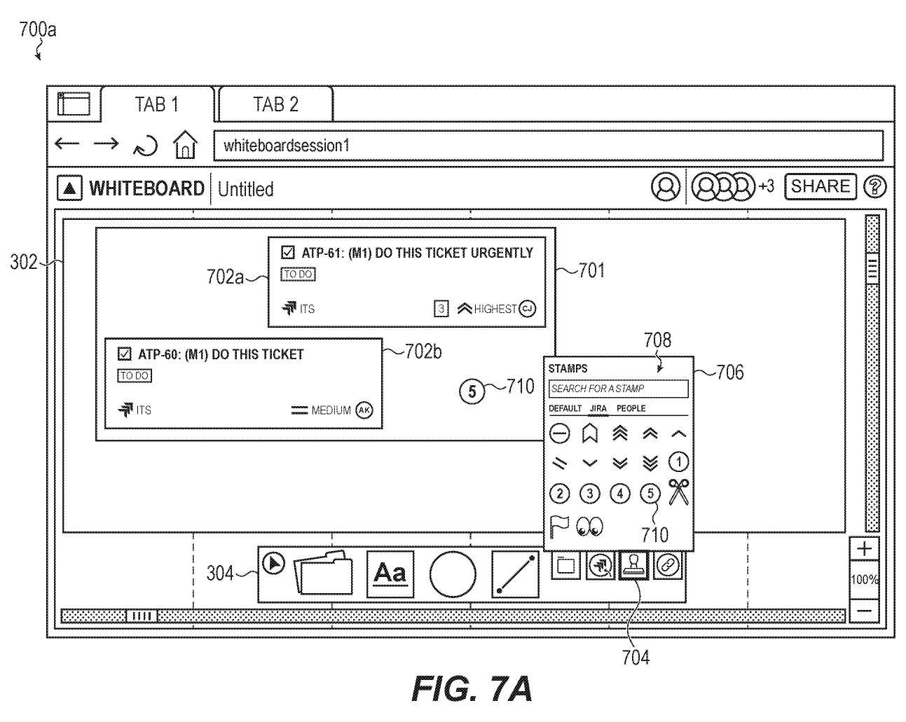

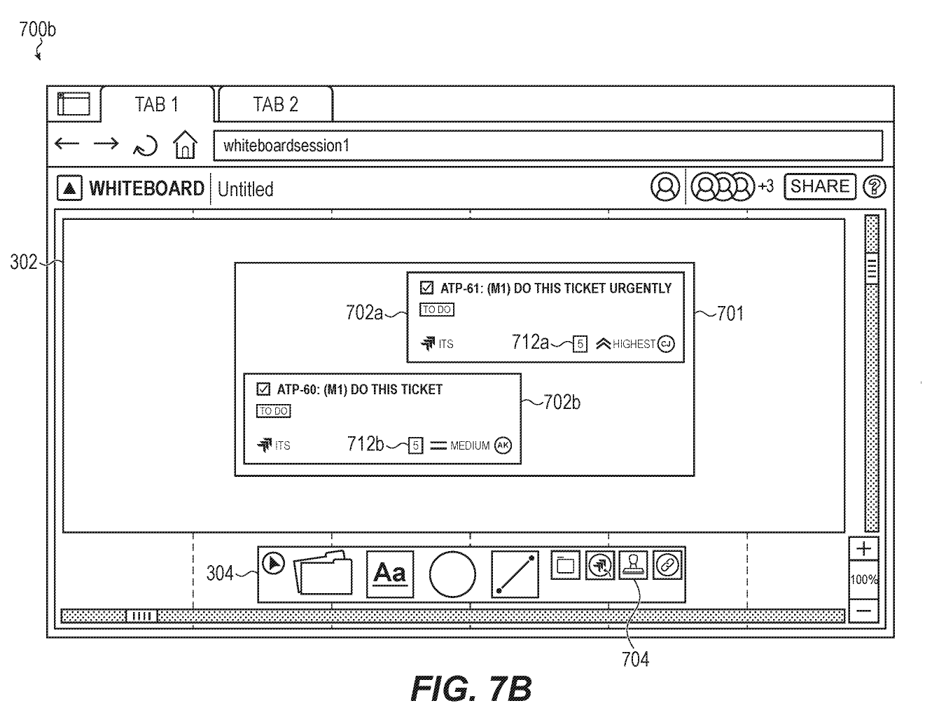

Graphical objects can include issue-based graphical objects 314a, 314b, note objects 316 (e.g., virtual sticky notes), emojis 318, like object 320, shapes, a text box, and/or other suitable graphical objects. As explained in FIGS. 7A–7B below, users may also place regions within the shared editor region which creates a sub-region within the whiteboard, allowing users to have more control over a region, move graphical objects within the region together, and/or block other users from moving content. Each graphical object from the quick access menu or primitive bar 304 can be placed freely (e.g., no restriction on locations, no restrictions about overlaps of existing objects, and so on) within the unstructured canvas. As users place objects in the canvas, the visible size of the canvas expands (e.g., in a 2D plane) to accommodate the content.

A participant user of the whiteboarding session and/or a host of the whiteboarding session may configure properties of the graphical object, for example, the shape, the size, and the color for each graphical object, according to various criteria as described herein. In some cases, the graphical objects may be created from object primitives or templates that preconfigure the object to a particular form or media type. Example object primitives include, note primitives, text primitives, emoji or sticker primitives, shape primitives, connector primitives, and automation or action primitives, as described herein. For example, the participant user of the whiteboarding session and/or the host of the whiteboarding session may designate one or more action regions using an action or automation primitive and configure rules to perform one or more actions and/or automations when a participant user of the whiteboarding session moves a graphical object into the respective action or automation region. An action or automation region, as described herein, may be a user-defined action region, or a pre-defined action region that is added by a participant user or a host user of the whiteboarding session for display on the virtual whiteboard graphical user interface. Properties of the pre-defined action region may be preconfigured and may not be updated by the participant user or the host user of the whiteboarding session. However, properties of the user-defined action region may be dynamically updated by the participant user or the host user of the whiteboarding session. The action region is displayed on the virtual whiteboard graphical user interface as distinct from the virtual canvas displayed on the virtual whiteboard graphical user interface.

Accordingly, participant users can collaborate using a virtual whiteboard, which is presented on a display of each client device as a virtual whiteboard graphical user interface, and automatically cause execution of an action according to the configured rules of an action region, when a participant user places a graphical object into the action region of the virtual whiteboard graphical user interface. The participant user may place the graphical object into the action region by dragging the graphical object from its current location in the virtual canvas on the virtual whiteboard graphical user interface to any place within the action region on the virtual whiteboard graphical user interface. Additionally, or alternatively, the participant user may edit properties of the graphical object corresponding to a display location of the graphical object on the virtual whiteboard graphical user interface to move the graphical object from the virtual canvas into the action region.

The issue-based graphical objects 314 may be a selectable graphical object each corresponding to a respective issue managed by the issue tracking platform. The issue-based graphical objects 314 may display information related to issue attributes for a respective issue. For example, a first issue-based graphical object 314a can display a title 322a, a current workflow state 324a, a priority 326a, and/or other information associated with/retrieved from attributes for a first issue managed by the issue tracking platform. A second issue-based graphical object can display a title 322b, a current workflow state 324b, a priority 326b, and/or other information associated with/retrieved from attributes for a second issue managed by the issue tracking platform. In some cases, as issue attributes are updated/changed at the issue tracking platform, the information displayed in the issue-based graphical objects 314 can be updated to reflect those changes. In some cases, each issue-based graphical object can include a synchronization indicator 328, which may indicate a synchronization status with the issue tracking platform. For example, a first synchronization indicator 328a can indicate whether the first issue-based graphical object 314a has been synchronized with the issue tracking platform and is displaying current information for the first issue. A second synchronization indicator 328b can indicate whether the second issue-based graphical object 314b has been synchronized with the issue tracking platform and is displaying current information for the first issue.

Additionally or alternatively, an issue-based graphical object 314 can be an active object that allows a user to change, modify or otherwise update attributes displayed in the respective issue-based graphical object 314 and cause those changes to be applied to the corresponding issue at the issue tracking platform. In some, cases, the synchronization indicator 328 can be used to indicate whether updates made to the issue-based graphical object 314 have been applied to the issue at the issue tracking platform.

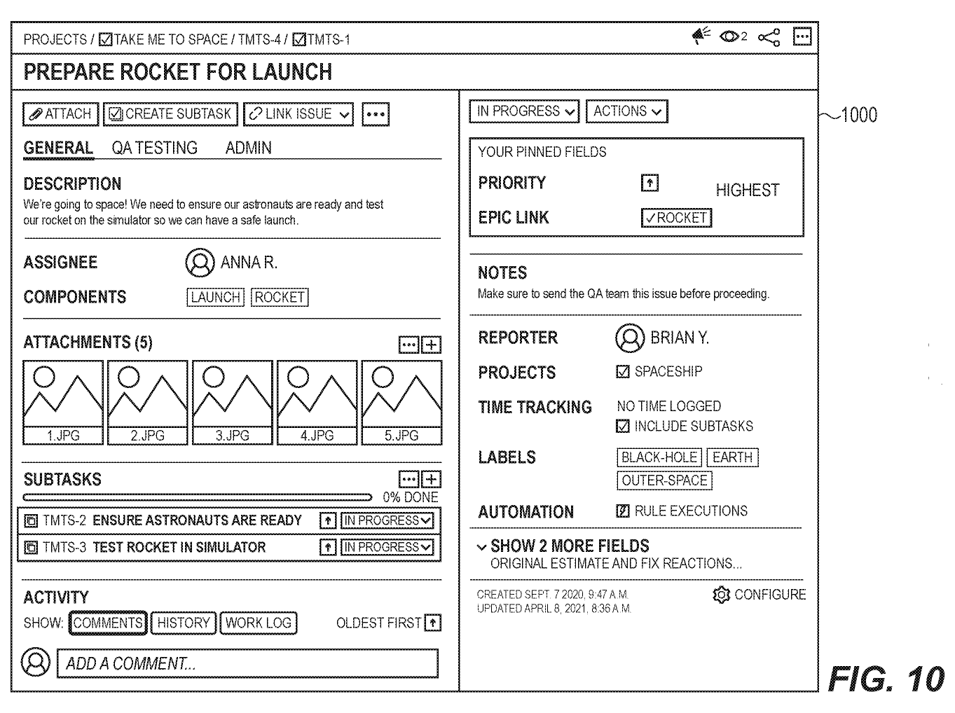

Each issue-based graphical object 314 may be selectable to view additional details related to a corresponding issue and/or to cause display of an issue view at the issue tracking platform. For example, a user input to the first issue-based graphical object 314a, may cause the system to open an issue view graphical user interface in the issue tracking platform. For example, FIG. 10 depicts an example graphical user interface for an issue view in the issue tracking platform.

In some cases, the issue-based graphical objects 314 corresponding to issues may be selectable and moveable in the graphical user interface of the virtual whiteboarding application so that users can intuitively and efficiently visually organize the issues. In some embodiments, the virtual whiteboarding application allows users to view and/or specify relationships between issue objects using connecting graphical wire element 330 between the issue-based graphical objects 314 corresponding to the issue objects. For example, the virtual whiteboarding application may allow users to visualize related issues to a particular issue, displaying graphical elements for each related issue and graphical wire 330 between the issue-based graphical objects 314. The graphical wires may represent dependencies between the issue objects defined at the issue tracking platform. Additional or alternatively, graphical wires may be added to the user interface, and may cause one or more dependencies to be created at the issue tracking platform. For example, in response to adding graphical wire 330, the whiteboard system may generate one or more API calls to the issue tracking platform to cause a dependent relationship to be created for the corresponding issue objects at the issue tracking platform.

In some cases, the whiteboarding platform can be configured to cause creation of new issues at the issue tracking platform. For example, adding an issue-based graphical object, from the primitive bar 304, may allow a user to enter issue data and cause creation of the issue at the issue tracking platform. Additionally or alternatively, the system may allow graphical objects such as sticky notes or text boxes to be converted into an issue-based graphical object 314. For example, a floating user menu 332 may be displayed as a result of a user selection of a graphical object, such as graphical object 316a. The floating user menu 332 has a variety of user controls, depending on the content and/or primitive of the graphical object 316. For example, the floating user menu 332 may include text format options, color changing options, emojis, and a “CREATE ISSUE” button 334. Using this interface, a user may quicky identify if an issue object should be created from the graphical object. In some embodiments, the “CREATE ISSUE” button 334 is selectively displayed depending on the content of the graphical object, primitive, and/or any other suitable criteria. For example, in response to a user selection of a sticky note without text, display of the “CREATE ISSUE” button may be suppressed. Similarly, in some embodiments, UI block types or primitives, such as lines, may not display a create issue option. In some examples, the primitive may be used to determine the issue type, project, and/or other issue fields. For example, a user selection of a line may be identified as a link of two existing issue objects. As another example, a user selection of a sticky note may be analyzed as a likely action item and the display of the issue creation window may be updated accordingly.

FIG. 3B depicts an example virtual whiteboard graphical user interface 300 in response to a user input selecting a collapsable graphical menu 310. The collapsable graphical menu 310 can include an icon that is selectable to cause display of an attribute menu 340. In some cases, the attribute menu 340 can include different sets of attribute elements 342. For example, the attribute menu can include a first set of attribute elements 342a (e.g., “Default”), which may include attribute elements such as emojis, stamps, and voting buttons (which may be referred to as “indicator attribute elements”). The indicator attribute elements may be visual elements. In some cases, indicator attribute elements may cause some function/action to be performed at the whiteboarding platform. For example, voting buttons applied to a particular region may be detected and analyzed by the whiteboarding platform to determine a vote tally/result, and update objects based on the determined result. The indicator attribute elements may be applied to issue-based graphical objects but may not be configured to cause any action at the issue tracking platform. For example, indicator attribute elements applied to issue-based graphical objects may be visual elements, only cause actions to be performed at the whiteboarding platform, and/or at some other system such as a document management system.

The functional characteristics of the issue attribute elements (and/or other attribute elements) may be based on their placement in the shared editor region and/or placement with respect to other object types in the shared editor region. For example, when issue attributes are positioned over and/or placed on an issue-based graphical object they can be configured to cause the corresponding issue object to be updated at the issue tracking platform. When an issue attribute element is placed at other locations on the shared editor region (e.g., on a blank portion, or over a sticky note or other object), the issue attribute element may be configured to function as a visual object (e.g., similar to indicator attribute elements) and may not cause any other actions to be performed. Accordingly, as issue attribute elements are placed in the shared editor region, the whiteboard platform can be configured to determine the functional of the attribute element based on its placement – e.g., as visual element or to cause a change to an issue object, as described herein. Additionally or alternatively, the whiteboarding platform may be configured to determine whether a user account that is placing an issue attribute element has permission to make the associated changes to an issue-object at the issue tracking platform, as described herein.

Additionally or alternatively, the attribute menu 340 can include a second set of attribute elements 340b (e.g., “ITS”), which may include elements that are associated with functions that can cause actions to be performed an issue tracking platform (which may be referred to as “issue attribute elements”). The issue attribute elements can each be associated with an issue attribute that can be applied to the issues and used to update the issue at the issue tracking platform. For example, a first type of issue attribute element may be configured to cause a change in the priority of an issue, and a third type of issue attribute element can be used to assign a resource estimate to an issue.

Additionally or alternatively, the attribute menu 340 can include a third set of attribute elements 340c (e.g., “People”), which may include elements that are associated with registered users of the whiteboarding platform and/or the issue tracking platform. In some cases, attribute elements form the third set of attribute elements 340c can cause a particular user to be assigned to the issue.

In some cases, user interface can be configured to apply the attribute elements using drag-and-drop operations. For example, a user input may be used to select a particular attribute element from the attribute menu 340, and dropping the particular element can cause the element to be displayed, permanently or temporarily, at the drop location. Additionally, in some cases, depending on functionality configured for a particular attribute, dropping the attribute at a specific location can cause the system to perform one or more actions, such as causing an issue to be updated at the issue tracking platform, as described herein.

Additionally or alternatively, drag-and-drop operations can be configured to replace a cursor in the graphical interface with a graphical icon for the selected attribute element. The attribute element may be moved around the shared editor region and applied to different areas, for example, using a click input operation. In some cases, the attribute element may persist and each application (e.g., click input) may cause the attribute element to be applied to the current location. For example, a first input (e.g., first click operation) at the first issue-based graphical object 314a can cause the attribute element to be applied to the first issue-based graphical object 314a and a second input (e.g., second click operation) can cause the attribute element to be applied to the second issue-based graphical object 314b. That is, the issue attribute element may function like a stamp, in that once selected, it can be applied “stamped” at multiple different locations in the shared editor region, and the whiteboard platform can determine actions to performed based on the location of the stamp, its relation to other graphical objects in the shared editor region, and/or permissions of a user applying (“stamping”) the attribute element.

In some cases, the system can be configured to determine if a particular attribute element can be applied to a region of that shared editor region 302. For example, if an issue attribute element is not over an issue-based graphical object 314, then the system may prevent the attribute element from being applied (e.g., grey out the element).

The attribute menu shown and described with respect to FIG. 3B and herein, provide examples of the concepts described herein. In some cases, the menus, icons, and/or other visual or graphical elements can be configured in a variety of different ways. For example, the attribute menu 340 may be arranged to have all the attribute elements displayed in a single set and the menu 340 may be configured to scroll and display additional attribute elements. Additionally or alternatively, the menu 340 may include a dynamic set that is populated with attributes based on one or more parameters, for example, a frequency or amount of use of particular attribute elements, recency of use of one or more attribute elements, and so on.

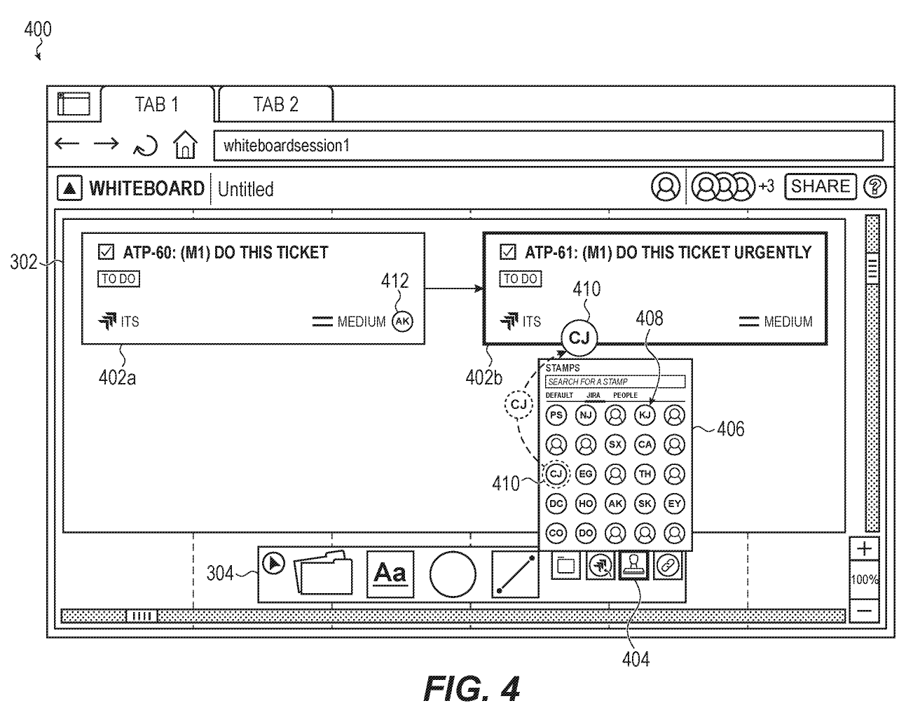

FIG. 4 depicts an example virtual whiteboard graphical user interface 400 having an issue attribute element used to modify an issue at an issue tracking platform (e.g., issue tracking platform 106). The virtual whiteboard interface 400 can be an example of the whiteboard interfaces described herein including whiteboard interface 300. The virtual whiteboard interface 400 can include a shared editor region 302, and a primitive menu 304, as described herein.

The shared editor region 302 depicts an example having a first issue-based graphical object 402a and a second issue-based graphical object 402b. The issue-based graphical objects 402 can be examples of the issue-based graphical objects described herein (e.g., issue-based graphical objects 314). The first issue-based graphical object 402a can be associated with a first issue managed by the issue tracking platform and display information related to one or more attributes for the first issue. The second issue-based graphical object 402b can be associated with a second issue managed by the issue tracking platform and display information related to one or more attributes for the second issue.

In some cases, the primitive menu 304 can include a collapsable graphical menu 404. The collapsable graphical menu 404 can include an icon that is selectable to cause display of an attribute menu 406. In some cases, the attribute menu 406 can include a set of attribute elements 408. The attribute elements 408 can be represented using graphical icons as shown in FIG. 4.

The attribute menu 406 can include a set of issue attribute elements 408 which are each associated with an issue attribute that can be applied to the issues and used to update the issue. For example, a first type of issue attribute element may be configured to cause a particular user to be assigned to the issue. In some cases, the attribute graphical menu can include multiple issue attribute elements 408 each associated with a different user account and configured to cause the respective user to be assigned to the issue. Accordingly, applying one or more of these issue attribute elements 408 to an issue-based graphical object 402 causes the respective user account to be assigned to the issue.

The set of issue attributes can include a first attribute element 410 that is associated with a particular user account and is configured to assign that user account to an issue. For example, a user input can cause a drag-and-drop operation to be performed using the first attribute element 410. In response to the user input causing the first attribute element to be dragged from the attribute menu 406 and applied to the second issue-based graphical object 402b, the system can cause the user account associated with the first attribute element 410 to be assigned to the second issue at the issue tracking platform (e.g., using issue tracking service 120 to initiate one or more API calls to issue tracking platform 106). Additionally, in response to the second issue being updated and the particular user account assigned to the second issue, the issue-based graphical object 402b can be updated to display a status element, which provides a graphical indicator the action has been performed. For example, the first issue-based graphical object 402a, shows a first status element 412, which indicates that a particular user account has been assigned to the first issue.

In some cases, each of the issue attribute elements 408 can include a unique element that associates a respective element with a particular user account. For example, each issue attribute element 408 may include a unique avatar, a user id, and/or any other suitable indicator. In some cases, the issue attribute elements 408, corresponding to particular user’s can be configured based on participants in the whiteboarding interface. For example, each issue attribute element 408 may correspond to a participant in the virtual whiteboard interface. Additionally or alternatively, the issue attribute elements 408 may include elements based on a project or team defined in the issue tracking platform. For example, the whiteboard platform may be configured to determine a team or project associated with a whiteboard session and/or issue-based graphical objects displayed in the shared editor region (e.g., using one or more API request to the issue tracking platform). The whiteboard platform may receive a set of user account associated with a particular project from the issue tracking platform, team, and/or issue object and be configured to generate issue attribute elements 408 using the received set of user accounts.

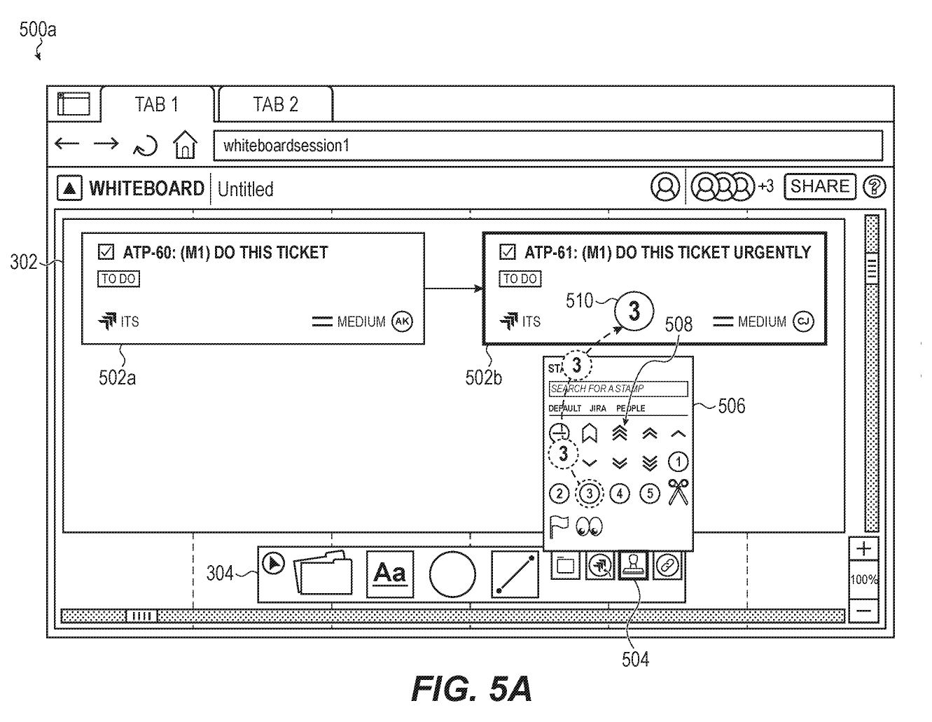

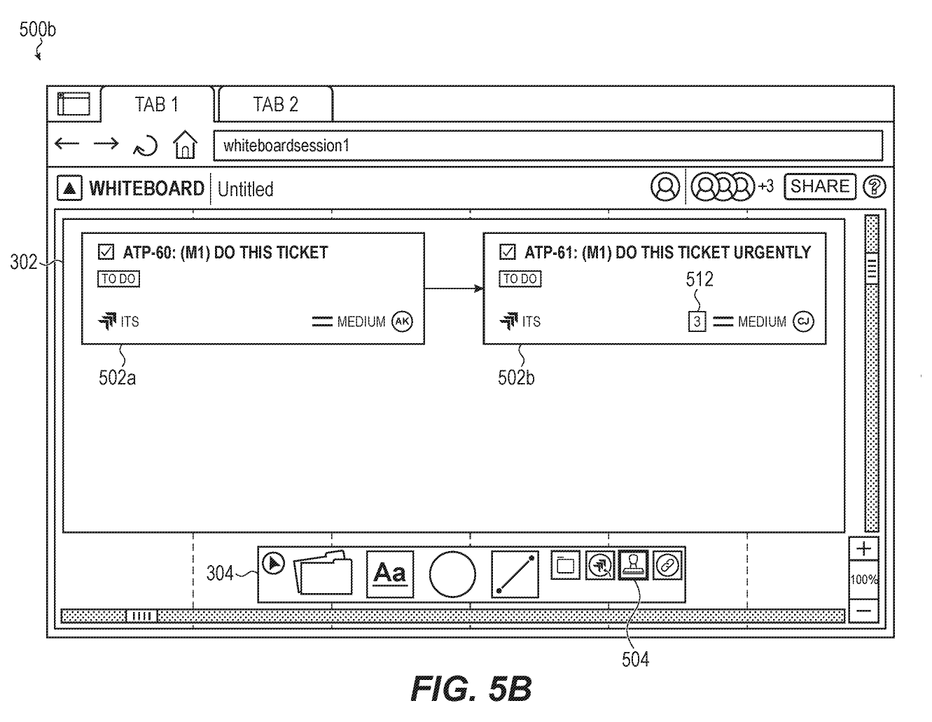

FIGS. 5A–5B depict an example virtual whiteboard graphical user interface 500 having an issue attribute element used to modify an issue element at an issue tracking platform (e.g., issue tracking platform 106). The virtual whiteboard interface 500 can be an example of the whiteboard interfaces described herein including whiteboard interfaces 300, 400. The virtual whiteboard interface 500 can include a shared editor region 302, and a primitive menu 304, as described herein.

The shared editor region 302 depicts an example having a first issue-based graphical object 502a and a second issue-based graphical object 502b. The issue-based graphical objects 502 can be examples of the issue-based graphical objects described herein (e.g., issue-based graphical objects 314, 402). The first issue-based graphical object 502a can be associated with a first issue managed by the issue tracking platform and display information related to one or more attributes for the first issue. The second issue-based graphical object 502b can be associated with a second issue managed by the issue tracking platform and display information related to one or more attributes for the second issue.

As shown in FIG. 5A, the primitive menu 304 can include a collapsable graphical menu 504. The collapsable graphical menu 504 can include an icon that is selectable to cause display of an attribute menu 506. In some cases, the attribute menu 506 can include a set of attribute elements 508, as described herein. The attribute elements 508 can be represented using graphical icons as shown in FIG. 5 and described herein.

The attribute graphical menu 504 can include a set of issue attribute elements 508 which are each associated with an issue attribute that can be applied to the issues and used to update the issue. For example, a first type of issue attribute element may be configured to cause a particular action to occur with respect to an issue. In some cases, the attribute graphical menu can include multiple issue attribute elements 508 each associated with a different action and/or attribute that can be applied to an issue managed by the issue tracking platform. Accordingly, applying one or more of these issue attribute elements 508 to an issue-based graphical object 502 causes the respective action and/or attribute to be applied to the respective issue.

As shown in FIG. 5A, the set of issue attribute elements 508 can include a first attribute element 510, configured to assign an estimated resource requirement to an issue. An estimated resource estimate can be a value that estimates the amount of effort, time, work required for a given issue or task as compared to other issues/tasks, as described herein. A user input can cause a drag-and-drop operation to be performed using the first attribute element 510. In response to the user input causing the first attribute element 510 to be applied to the second issue-based graphical object 502b, the system can cause the corresponding resource estimate (e.g., a value of “3”) to be applied to the second issue at the issue tracking platform (e.g., using issue tracking service 120 to initiate one or more API calls to issue tracking platform 106).

As shown in FIG. 5B, in response to the second issue being updated and the resource estimate being applied to the second issue, the second issue-based graphical object 502b can be updated to display a status element 512, which provides a graphical indicator the action has been performed. For example, the second issue-based graphical object 502b, shows the status element 512, which indicates that the second issue has been updated in accordance with the applied resource estimate.

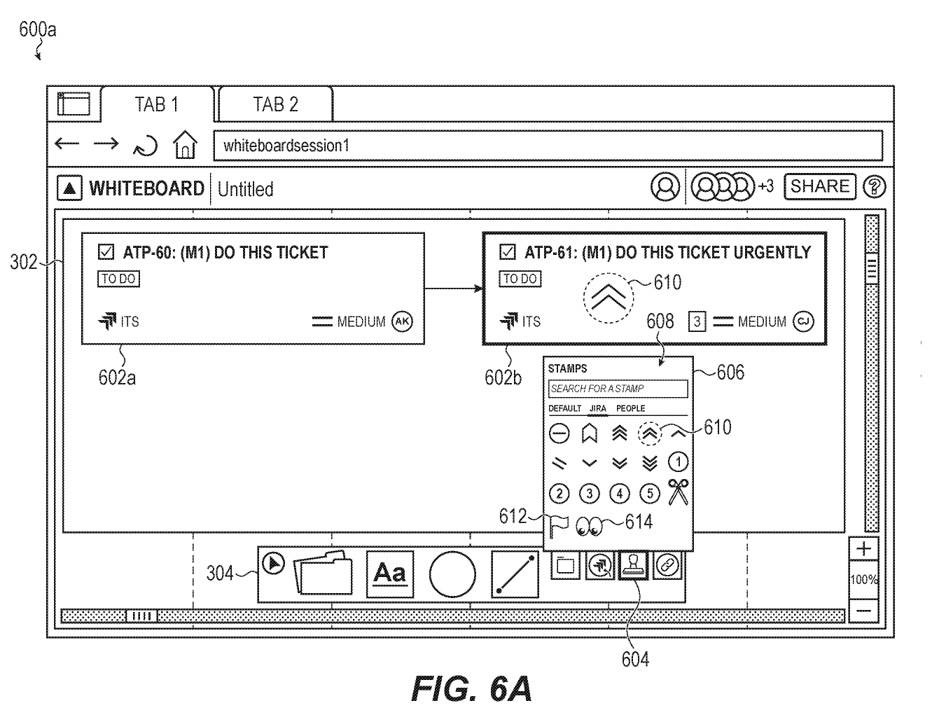

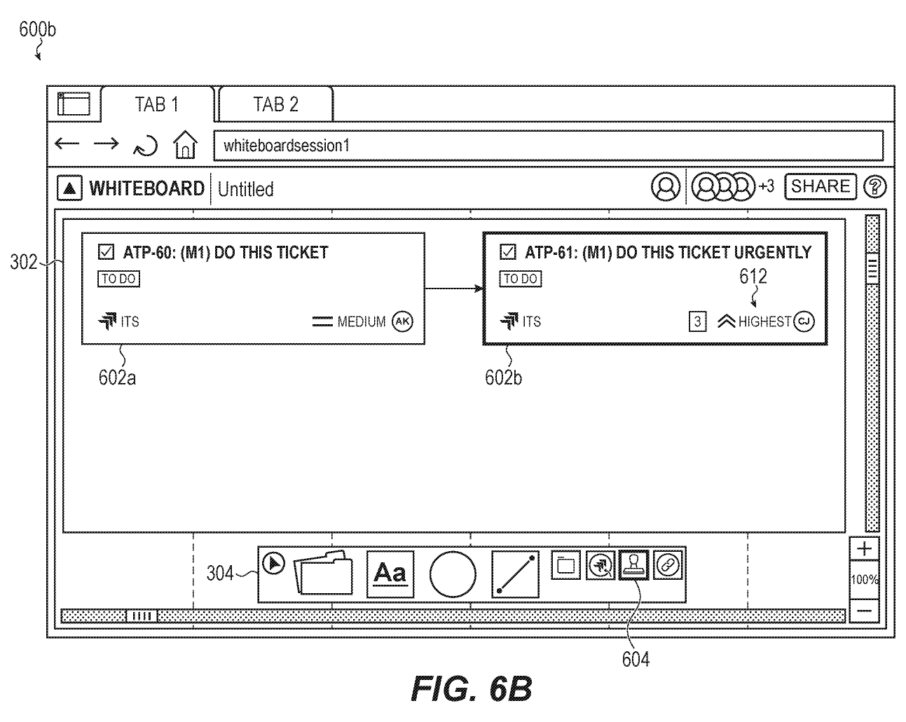

FIGS. 6A–6B depict an example virtual whiteboard graphical user interface 600 having an issue attribute element used to modify an issue element at an issue tracking platform (e.g., issue tracking platform 106). The virtual whiteboard interface 600 can be an example of the whiteboard interfaces described herein including whiteboard interfaces 300, 400, 500. The virtual whiteboard interface 600 can include a shared editor region 302, and a primitive menu 304, as described herein.

The shared editor region 302 depicts an example having a first issue-based graphical object 602a and a second issue-based graphical object 602b. The issue-based graphical objects 602 can be examples of the issue-based graphical objects described herein (e.g., issue-based graphical objects 314, 402, 502). The first issue-based graphical object 502a can be associated with a first issue managed by the issue tracking platform and display information related to one or more attributes for the first issue. The second issue-based graphical object 502b can be associated with a second issue managed by the issue tracking platform and display information related to one or more attributes for the second issue.

As shown in FIG. 6A, the primitive menu 304 can include a collapsable graphical menu 504. The collapsable graphical menu 604 can include an icon that is selectable to cause display of an attribute menu 606. In some cases, the attribute menu 606 can include a set of attribute elements 608, as described herein. The attribute elements 608 can be represented using graphical icons as shown in FIG. 6 and described herein.

The attribute graphical menu 604 can include a set of issue attribute elements 608 which are each associated with an issue attribute that can be applied to the issues and used to update the issue. For example, a first type of issue attribute element may be configured to cause a particular action to occur with respect to an issue. In some cases, the attribute graphical menu can include multiple issue attribute elements 608 each associated with a different action and/or attribute that can be applied to an issue managed by the issue tracking platform. Accordingly, applying one or more of these issue attribute elements 608 to an issue-based graphical object 602 causes the respective action and/or attribute to be applied to the respective issue.

As shown in FIG. 6A, the set of issue attribute elements 608 can include a first attribute element 610 this is configured to apply, change, or update a priority attribute for an issue. A user input can cause a drag-and-drop operation to be performed using the first attribute element 610. In response to the user input causing the first attribute element 610 to be applied to the second issue-based graphical object 602b, the system can cause the corresponding priority to be applied to the second issue at the issue tracking platform (e.g., using issue tracking service 120 to initiate one or more API calls to issue tracking platform 106).

As shown in FIG. 6B, in response to the second issue being updated and the resource estimate being applied to the second issue, the issue-based graphical object 602b can be updated to display a status element 612, which provides a graphical indicator the action has been performed. For example, the second issue-based graphical object 602b, shows the status element 612, which indicates that the second issue has been updated in accordance with the applied priority.

In some cases, the issue attribute elements can include attribute elements that cause an action to be performed at the issue tracking platform but may not cause display of status element or other change to an issue-based graphical object 602. As shown in FIG. 6A, a second issue attribute element 612 can be configured to flag an issue for a user account that applies the second issue attribute element 612 to an issue-based graphical object 602. For example, if a first user associated with a first user account and accessing the whiteboarding platform through a first instance of the graphical user interface, applies the second issue attribute element 612 to the first issue-based graphical object 602a, the virtual whiteboard system can cause the issue tracking platform to perform actions associated with the “flag” function of the second issue attribute element. For example, the whiteboarding platform may send an indication of the user account and request for the first issue to be updated in accordance with the flag function at the issue tracking platform. In response, the issue tracking platform may add the first issue to issues associated with the first user account.

Additionally, in some cases, in response to the second issue attribute element 612 being applied to the first issue-based graphical object 602a, the graphical interface 600a may be configured to temporarily display the graphical icon for the second issue attribute element 612 at the first issue-based graphical object 602a and/or perform other temporary graphical effects that indicate that the attribute element was applied. Accordingly, in some cases, attribute elements applied to an issue-based graphical object 602 may cause a temporary visual indicator to be displayed, but not cause a change to the information displayed in the issue-based graphical object 602.

Additionally or alternatively as shown in FIG. 6A, a third issue attribute element 614 can be configured to provide updates to a particular user account for an issue. For example, if a first user associated with a first user account and accessing the whiteboarding platform through a first instance of the graphical user interface, applies the third issue attribute element 614 to the first issue-based graphical object 602a, the virtual whiteboard system can cause the issue tracking platform to perform actions associated with a “watch” function of the third issue attribute element 614. For example, the whiteboarding platform may send an indication of the user account and request for the first issue to be updated in accordance with the watch function to the issue tracking platform. In response to the communication from the whiteboarding application, the issue tracking platform can be configured to identify a corresponding user account at the issue tracking platform and add that account as a subscriber to the corresponding issue object. In response, the issue tracking platform may send updates to the first user account via the issue tracking platform and outside of the whiteboarding application, for example in response to changes to attributes of the first issue (e.g., status update, priority change, and so on).

FIGS. 7A–7B depict an example virtual whiteboard graphical user interface 700 having an issue attribute element applied to a sub-region within the interface at an issue tracking platform (e.g., issue tracking platform 106). The virtual whiteboard interface 700 can be an example of the whiteboard interfaces described herein including whiteboard interfaces 300, 400, 500, 600. The virtual whiteboard interface 700 can include a shared editor region 302, and a primitive menu 304, as described herein.

The shared editor region 302 depicts an example having a first issue-based graphical object 702a and a second issue-based graphical object 702b. The issue-based graphical objects 702 can be examples of the issue-based graphical objects described herein (e.g., issue-based graphical objects 314, 402, 502, 602). The first issue-based graphical object 702a can be associated with a first issue managed by the issue tracking platform and display information related to one or more attributes for the first issue. The second issue-based graphical object 702b can be associated with a second issue managed by the issue tracking platform and display information related to one or more attributes for the second issue.

As shown in FIG. 7A, the primitive menu 304 can include a collapsable graphical menu 704. The collapsable graphical menu 704 can include an icon that is selectable to cause display of an attribute menu 706. In some cases, the attribute menu 706 can include a set of attribute elements 708, as described herein. The attribute elements 708 can be represented using graphical icons as shown in FIG. 7 and described herein.

The whiteboarding platform can be configured to define one or more regions 701 within the shared editor region 302. Each region 701 can be configured to group graphical elements contained within the region, as described herein. In some cases, attribute elements applied to a region can be configured to be applied to each graphical object contained within the region. For example, a first issue attribute 710 can be applied to the region 701, as described herein. In response to the first issue attribute 710 being applied to region 701, the whiteboarding platform can be configured to cause both a first issue associated with the first issue-based graphical object 702a and a second issue associated with the second graphical element 702b to be updated at the issue tracking platform.

As shown in FIG. 7B, in response to the first issues and the second issue being updated, the issue first graphical element 702a to display a first status element 712a and the second issue-based graphical object 702b can be updated to display a second status element 712b, each of which provides a graphical indicator the action has been performed. For example, the first issue-based graphical object 702a, shows the first status element 712a, and the second issue-based graphical object shows the second status element 712b, which each indicate that the first and second issues have been updated in accordance with the issue attribute element applied to the region 701.

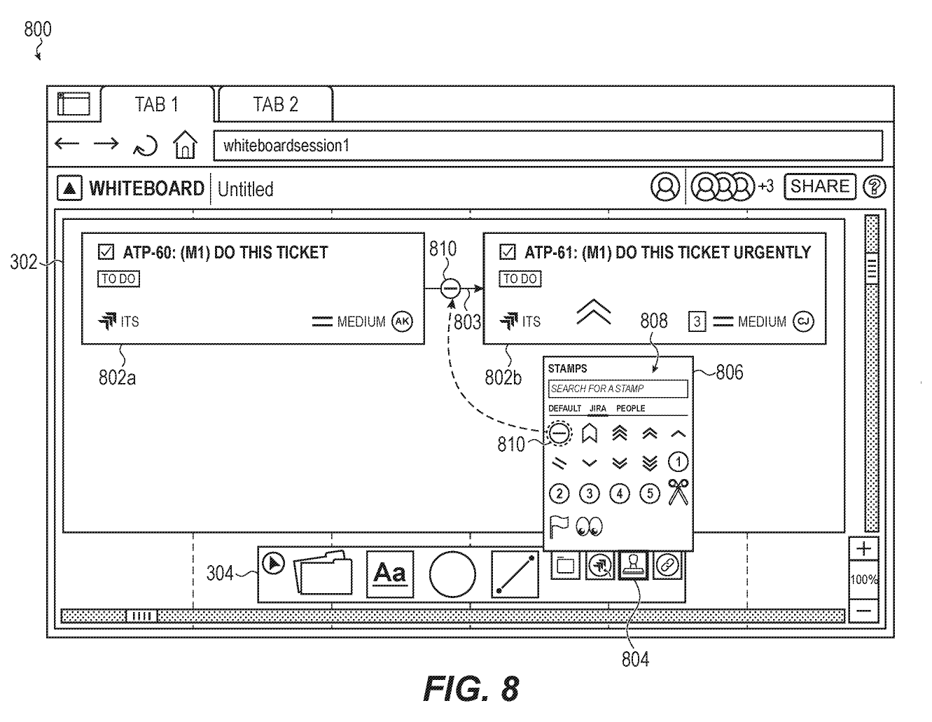

FIG. 8 depicts an example virtual whiteboard graphical user interface 800 having an issue attribute element applied to a dependency graphical element within the interface at an issue tracking platform (e.g., issue tracking platform 106). The virtual whiteboard interface 800 can be an example of the whiteboard interfaces described herein including whiteboard interfaces 300, 400, 500, 600, 700. The virtual whiteboard interface 800 can include a shared editor region 302, and a primitive menu 304, as described herein.

The shared editor region 302 depicts an example having a first issue-based graphical object 702a and a second issue-based graphical object 802b. The issue-based graphical objects 802 can be examples of the issue-based graphical objects described herein (e.g., issue-based graphical objects 314, 402, 502, 602, 702). The first issue-based graphical object 802a can be associated with a first issue managed by the issue tracking platform and display information related to one or more attributes for the first issue. The second issue-based graphical object 802b can be associated with a second issue managed by the issue tracking platform and display information related to one or more attributes for the second issue.

The first issue and the second issue can have a dependent relationship defined at the issue tracking platform, which can be indicated using wire graphical element 803. For example, the second issue may be dependent on the first issue. Issue dependencies can define which issues or rely on other issues and issue links (e.g., show using wire element 803) to represent relationships between issues. Dependencies may include task dependencies, where one task relies on the completion of another; resource dependencies, where tasks are dependent on specific resources; schedule dependencies, where task timelines are interlinked; and so on. Examples of dependency that can be defined for issues at the issue tracking platform include, a finish-to-start dependency, where a first task must be complete for a second task to begin (which may also be referred to as “blocked by”); a start-to-start dependency where a first task must start for a second task to start; a finish-to-finish dependency where a first task must be complete for a second task to complete; a start-to-finish dependency where a first task cannot be completed until a second task has begun; an external dependency which include dependencies on external applications or platform; and so on.

As shown in FIG. 8, the primitive menu 304 can include a collapsable graphical menu 804. The collapsable graphical menu 804 can include an icon that is selectable to cause display of an attribute menu 806. In some cases, the attribute menu 806 can include a set of attribute elements 808, as described herein. The attribute elements 808 can be represented using graphical icons as shown in FIG. 8 and described herein.

In some cases, the virtual whiteboard can include attribute elements that are configured to change a dependency between issues. For example, attribute element 810 can be configured to change a dependency between the first issue and the second issue. A user input can cause a drag-and-drop operation to be performed using the attribute element 810. In response to the user input causing the attribute element 810 to be applied to the wire element 803, the system can cause the corresponding dependency (e.g., blocked by) to be updated at the issue tracking platform (e.g., using issue tracking service 120 to initiate one or more API calls to issue tracking platform 106).

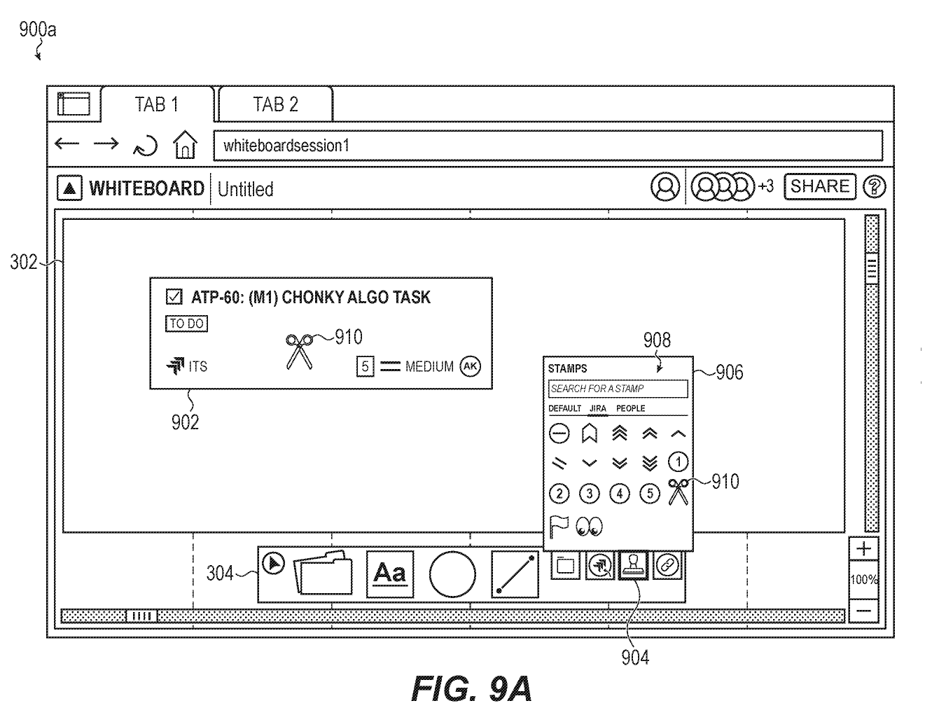

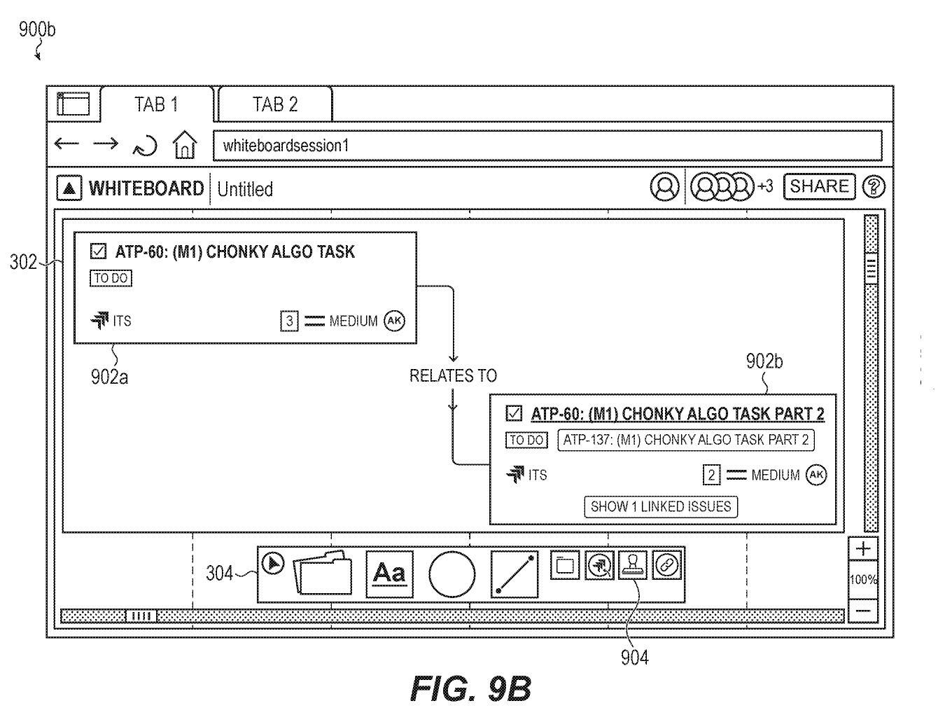

FIGS. 9A–9B depict an example virtual whiteboard graphical user interface 900 having an issue attribute element used to split an issue into multiple issues at an issue tracking platform (e.g., issue tracking platform 106). The virtual whiteboard interface 900 can be an example of the whiteboard interfaces described herein including whiteboard interfaces 300, 400, 500, 600, 700, 800. The virtual whiteboard interface 900 can include a shared editor region 302, and a primitive menu 304, as described herein.

As shown in FIG. 9A, the shared editor region 302 depicts an example having an issue-based graphical object 902. The issue-based graphical objects 902 can be examples of the issue-based graphical objects described herein (e.g., issue-based graphical objects 314, 402, 502, 602, 702, 802). The issue-based graphical object 902 can be associated with an issue managed by the issue tracking platform and display information related to one or more attributes for the issue.

As shown in FIG. 9A, the primitive menu 304 can include a collapsable graphical menu 904. The collapsable graphical menu 904 can include an icon that is selectable to cause display of an attribute menu 906. In some cases, the attribute menu 906 can include a set of attribute elements 908, as described herein. The attribute elements 908 can be represented using graphical icons as shown in FIG. 9 and described herein.

In some cases, the virtual whiteboard can include attribute elements that are configured to split an issue into multiple issues. For example, attribute element 910 can be configured to split the issue into multiple issues at the issue tracking platform. A user input can cause a drag-and-drop operation to be performed using the attribute element 910. In response to the user input causing the attribute element 910 to be applied to the issue-based graphical object 902, the system can cause the corresponding issue to be split into two dependent issues at the issue tracking platform (e.g., using issue tracking service 120 to initiate one or more API calls to issue tracking platform 106).

As shown in FIG. 9B, the graphical interface 900b can be updated to display the multiple issues. For example, the graphical interface 900b shows a first issue-based graphical object 902a and a second issue-based graphical object 902b, which are created as a result of the split operation. In response to the split function, the issue tracking platform can be configured to generate multiple issue objects and the whiteboarding application can be configured to update the graphical interface, as shown in FIG. 9B, to display multiple issue-based graphical objects, 902a, 902b. The issue tracking platform may create multiple issues by copying content from the original issue and/or creating dependencies between the multiple issues. For example, if the original issue object, corresponding to issue-based graphical object 902, had multiple tasks, the issue tracking platform may create a first issue object including a first portion of the multiple tasks and a second issue object including a second portion of the multiple tasks.

Selectable graphical objects in the virtual whiteboard that correspond to issue objects in the issue tracking platform and may be selectable to display additional information about the issue in the graphical user interface of the virtual whiteboarding application or in a graphical user interface of the issue tracking platform. FIG. 10 depicts an example graphical user interface 1000 of an issue tracking platform. Specifically, the graphical user interface 1000 depicts issue object data associated with an issue managed and tracked by a corresponding issue tracking platform or platform. The graphical user interface 1000 may be displayed in response to a user selection of one of the issue objects described herein. The graphical user interface 1000 may be provided by a frontend or client of an issue tracking platform executing or operating on a client device. The graphical user interface 1000 may include various issues or object data that is associated with the respective issue. As described previously, some of these issue data may be used to generate the issue-based graphical objects in the virtual whiteboarding application. Changes to the issue data occurring due to input received at the graphical user interface 1000 or otherwise implemented by the issue tracking platform will automatically be updated when the issue-based graphical object is loaded or refreshed. The graphical user interface 1000 depicts the issue on a single screen, however, the issue data may be displayed using a series of tabs or links available through the graphical user interface 1000.

As shown in FIG. 10, the issue data includes text stored as fields or elements of the issue object. Issue fields include, for example, issue title, issue description, notes, and comments. Other issue data may include attachments or non-text content that is associated or stored with the issue object. Example non-text content includes screenshots, diagrams, and other graphical content that may be stored as image or other media files. Other example attachment content includes source code files, test results, user logs, and other similar content. The issue data may also include references or links to other system objects including, for example, projects or epics, which may have a parent-child relationship with the particular issue. Similarly, the issue data may include references or links to other issues identified as subtasks of the issue and may have a child-parent relationship with the particular issue. The issue data may also include references or pointers to other system elements like a system user or user profile identified as an assignee, owner, reviewer, or other role associated with the issue object.

In some cases, data/text or other information stored in one or more fields or elements may be modified using the whiteboard application, for example, by making changes to a corresponding issue-based graphical object and/or applying an issue attribute element to a corresponding issue -based graphical element. For example, if a user modifies a title of an issue-based graphical object, the whiteboarding platform may cause the title of the corresponding issue object to be updated at the issue tracking platform.

While the foregoing discussion is directed to issue objects in the whiteboarding platform corresponding to issues managed by the issue tracking platform, the same principles apply to objects managed by any third-party system. For example, the same principles apply to content items managed by a content management system, mockup items managed by a user interface design system, or any other objects managed by any other third-party system. The virtual whiteboarding application may operate as described above to generate graphical elements corresponding to an object managed by a third-party system, accept user input for moving or modifying the graphical elements and, thus, the objects corresponding thereto, relate graphical elements and, thus, the objects corresponding thereto, and visualize relationships between objects.

FIG. 11 shows a sample electrical block diagram of an electronic device(s) 1100 that may perform the operations described herein. For example, the electrical block diagram illustrates example components such as memory that stores instructions for performing the processes described herein and one or more processes, and/or other computer components that are configured to execute the stored instructions to perform the processes described herein. The electronic device(s) 1100 may in some cases take the form of any of the electronic devices described with reference to FIGS. 1–10 including client devices, and/or servers or other computing devices associated with the system 100. The electronic device 1100 can include one or more of a processing unit 1102, a memory 1104 or storage device, input device(s) 1106, a display 1108, output device(s) 1110, and a power source 1112. In some cases, various implementations of the electronic device 1100 may lack some or all of these components and/or include additional or alternative components.

The processing unit 1102 can control some or all of the operations of the electronic device 1100. The processing unit 1102 can communicate, either directly or indirectly, with some or all of the components of the electronic device 1100. For example, a system bus or other communication mechanism 1114 can provide communication between the processing unit 1102, the power source 1112, the memory 1104, the input device(s) 1106, and the output device(s) 1110. The processing unit 1102 may be operably coupled to the computer-readable memory 1104, which stores computer-readable instructions. The computer-readable instructions, when executed by the processing unit 1102 may cause the device or system to perform operations described herein with respect to the example embodiments and processes.

The processing unit 1102 can be implemented as any electronic device capable of processing, receiving, or transmitting data or instructions. For example, the processing unit 1102 can be a microprocessor, a central processing unit (CPU), an application-specific integrated circuit (ASIC), a digital signal processor (DSP), or combinations of such devices. As described herein, the term "processing unit" is meant to encompass a single processor or processing unit, multiple processors, multiple processing units, or other suitably configured computing element or elements.

It should be noted that the components of the electronic device 1100 can be controlled by multiple processing units. For example, select components of the electronic device 1100 (e.g., an input device 1106) may be controlled by a first processing unit and other components of the electronic device 1100 (e.g., the display 1108) may be controlled by a second processing unit, where the first and second processing units may or may not be in communication with each other.

The power source 1112 can be implemented with any device capable of providing energy to the electronic device 1100. For example, the power source 1112 may be one or more batteries or rechargeable batteries. Additionally, or alternatively, the power source 1112 can be a power connector or power cord that connects the electronic device 1100 to another power source, such as a wall outlet.

The memory 1104 can store electronic data that can be used by the electronic device 1100. For example, the memory 1104 can store electronic data or content such as audio and video files, documents and applications, device settings and user preferences, timing signals, control signals, and data structures or databases. The memory 1104 can be configured as any type of memory. By way of example only, the memory 1104 can be implemented as random access memory, read-only memory, flash memory, removable memory, other types of storage elements, or combinations of such devices.

In various embodiments, the display 1108 provides a graphical output, for example, associated with an operating system, user interface, and/or applications of the electronic device 1100 (e.g., a chat user interface, an issue-tracking user interface, an issue-discovery user interface, etc.). In one embodiment, the display 1108 includes one or more sensors and is configured as a touch-sensitive (e.g., single-touch, multi-touch) and/or force-sensitive display to receive inputs from a user. For example, the display 1108 may be integrated with a touch sensor (e.g., a capacitive touch sensor) and/or a force sensor to provide a touch- and/or force-sensitive display. The display 1108 is operably coupled to the processing unit 1102 of the electronic device 1100.

The display 1108 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1108 is positioned beneath and viewable through a cover that forms at least a portion of an enclosure of the electronic device 1100.

In various embodiments, the input device(s) 1106 may include any suitable components for detecting inputs. Examples of input device(s) 1106 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1106 may be configured to detect one or more particular types of input and provide a signal (e.g., an input signal) corresponding to the detected input. The signal may be provided, for example, to the processing unit 1102.

As discussed above, in some cases, the input device(s) 1106 may include a touch sensor (e.g., a capacitive touch sensor) integrated with the display 1108 to provide a touch-sensitive display. Similarly, in some cases, the input device(s) 1106 may include a force sensor (e.g., a capacitive force sensor) integrated with the display 1108 to provide a force-sensitive display.

The output device(s) 1110 may include any suitable components for providing outputs. Examples of output device(s) 1110 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1110 may be configured to receive one or more signals (e.g., an output signal provided by the processing unit 1102) and provide an output corresponding to the signal.

In some cases, input devices 1106 and output devices 1110 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1102 may be operably coupled to the input devices 1106 and the output devices 1110. The processing unit 1102 may be adapted to exchange signals with the input devices 1106 and the output devices 1110. For example, the processing unit 1102 may receive an input signal from an input device 1106 that corresponds to an input detected by the input device 1106. The processing unit 1102 may interpret the received input signal to determine whether to provide and/or change one or more outputs in response to the input signal. The processing unit 1102 may then send an output signal to one or more of the output devices 1110, to provide and/or change outputs as appropriate.

As used herein, the phrase "at least one of" preceding a series of items, with the term "and" or "or" to separate any of the items, modifies the list as a whole, rather than each member of the list. The phrase "at least one of" does not require selection of at least one of each item listed; rather, the phrase allows a meaning that includes at a minimum one of any of the items, and/or at a minimum one of any combination of the items, and/or at a minimum one of each of the items. By way of example, the phrases "at least one of A, B, and C" or "at least one of A, B, or C" each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but should instead be defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated by leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database. whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A computer implemented method for operating a virtual whiteboarding platform to manage issue objects managed by an issue tracking platform, the method comprising:
causing display of a graphical user interface of the virtual whiteboarding platform using a platform frontend executing on a client device, the virtual whiteboarding platform configured to receive concurrent inputs from each of multiple client devices, each executing a respective platform frontend, the graphical user interface comprising a shared editor region displayed on each respective graphical user interface of the respective platform frontend and configured to generate graphical objects in response to inputs received from the multiple client devices;
causing display of an issue-based graphical object in the shared editor region, the issue-based graphical object displaying data extracted from an issue managed by the issue tracking platform and being a selectable graphical object to cause redirection to a corresponding issue view in a user interface of the issue tracking platform;
causing display of an attribute graphical menu comprising a set of attribute elements that can be applied to the shared editor region, the set of attribute elements comprising one or more issue attribute elements, each issue attribute element of the one or more issue attribute elements associated with an attribute of an issue object hosted by the issue tracking platform; and
in response to a user input, positioning an attribute element, from the set of attribute elements, on the issue-based graphical object and determining that the attribute element corresponds to an issue attribute element of the one or more issue attribute elements:
causing the whiteboarding platform to access a gateway of the issue tracking platform and causing, via the gateway, a modification to the attribute of the issue object corresponding to the issue attribute element; and
causing the attribute element to be removed from the issue-based graphical object and causing display of an update of the issue-based graphical object displayed in the shared editor region, the update indicating the modification to the attribute of the issue object on the issue tracking platform.

2. The computer implemented method of claim 1, wherein:
the user input comprises a user selection of the attribute element from the issue attribute graphical menu and a cursor move operation to the issue-based graphical object within the shared editor region;
in response to completion of the user input, causing display of the attribute element at a first location on the issue-based graphical object; and
in response to displaying the update to the issue-based graphical object removing the attribute element from display within the shared editor region.

3. The computer implemented method of claim 2, wherein in response to the user input, positioning an attribute element, from the set of attribute elements, on the issue-based graphical object and determining that the attribute element does not correspond to an issue attribute element of the one or more issue attribute elements, causing the attribute element to be displayed with the issue-based graphical object.

4. The computer implemented method of claim 1, wherein placement of the attribute element on the issue-based graphical object causes a modification of an assigned state of the issue object hosted by the issue tracking platform.

5. The computer implemented method of claim 1, wherein placement of the attribute element on the issue-based graphical object causes:
multiple, dependent issue objects to be created from the issue object at the issue tracking platform; and
display of multiple issue-based graphical objects, each corresponding to one of the multiple issue objects.

6. The computer implemented method of claim 1, wherein placement of the attribute element on the issue-based graphical object causes a modification of an assigned user account of the issue object hosted by the issue tracking platform.

7. The computer implemented method of claim 1, wherein placement of the attribute element on the issue-based graphical object causes a modification of a priority level of the issue object hosted by the issue tracking platform.

8. The computer implemented method of claim 1, wherein placement of the attribute element on the issue-based graphical object causes a modification of a resource estimate of the issue object hosted by the issue tracking platform.

9. The computer implemented method of claim 1, wherein placement of the issue attribute element on the issue-based graphical object causes a user account in the issue tracking platform that corresponds to the user input to be subscribed to event notifications for the issue object at the issue tracking platform.

10. The computer implemented method of claim 1, wherein the issue-based graphical object is a first issue-based graphical object, the issue object is a first issue object, and the method further comprises:
causing display of a second issue-based graphical object in the shared editor region, the second issue-based graphical object associated with a second issue object hosted by the issue tracking platform, the second issue object having a dependent relationship to the first issue object;
causing display of a graphical wiring element between the first issue-based graphical object and the second issue-based graphical object, the graphical wiring element indicating the dependent relationship of the first issue object and the second issue object; and
subsequent to placement of an issue attribute element on the graphical wiring element, evaluating a modification associated with the issue attribute element with respect to the first issue object and the second issue object; and
in accordance with the proposed modification applying to the second issue object, cause a modification to the second issue object at the issue tracking platform.

11. A computer implemented method for using a virtual whiteboarding platform to update issue objects managed by an issue tracking platform, the method comprising:
causing display of a graphical user interface of the virtual whiteboarding platform using a platform frontend executing on a client device, the virtual whiteboarding platform configured to receive concurrent inputs from each of multiple client devices, each executing a respective platform frontend, the graphical user interface comprising a shared editor region displayed on each respective graphical user interface of the respective platform frontend and configured to generate graphical objects in response to inputs received from the multiple client devices;
causing display of a first issue-based graphical object in the shared editor region,
the first issue-based graphical object displaying data extracted from a first issue object managed by the issue tracking platform and being a first selectable graphical object to cause redirection to a first corresponding issue view in a user interface of the issue tracking platform;
causing display of a second issue-based graphical object in the shared editor region, the second issue-based graphical object displaying data extracted from a second issue object managed by the issue tracking platform and being a second selectable graphical object to cause redirection to a second corresponding issue view in the user interface of the issue tracking platform;
causing display of an attribute graphical menu comprising a set of attribute elements that can be applied to the shared editor region, the set of attribute elements comprising one or more issue attribute elements, each issue attribute element of the one or more issue attribute elements associated with an issue attribute that can be applied to an issue object at the issue tracking platform; and
in response to a user input applying an attribute element, from the set of attribute elements, to a sub-region comprising the first issue-based graphical object and the second issue-based graphical object, causing the whiteboarding platform to access a gateway of the issue tracking platform and causing, via the gateway, a modification to an attribute of the first issue object and an attribute of the second issue object at the issue tracking platform.

12. The computer implemented method of claim 11, further comprising:
receiving an input from the client device designating the sub-region within the shared editor region, the sub-region comprising multiple graphical objects;
analyzing each of the multiple graphical objects within the sub-region to determine a set of issue-based graphical objects corresponding to issue objects hosted by the issue tracking platform and non-issue graphical objects; and
causing a modification to each issue object of the set of issue-based graphical objects and no modifications to the non-issue graphical objects.

13. The computer implemented method of claim 11, wherein in response to the user input applying the attribute element to the sub-region comprising the first issue-based graphical object and the second issue-based graphical object, causing updates of the first issue-based graphical object and the second issue-based graphical object displayed in the shared editor region, the updates indicating the modifications to a respective attribute of the first issue object and the second issue object at the issue tracking platform.

14. The computer implemented method of claim 11, wherein placement of the attribute element on an issue-based graphical object causes a modification of an assigned user account of a corresponding issue object hosted by the issue tracking platform.

15. The computer implemented method of claim 11, wherein placement of the attribute element on an issue-based graphical object causes a modification of an assigned priority level of a corresponding issue object hosted by the issue tracking platform.

16. The computer implemented method of claim 11, wherein placement of the attribute element on an issue-based graphical object causes a modification of a resource estimate of a corresponding issue object hosted by the issue tracking platform.

17. A virtual whiteboard system operating on one or more servers, the virtual whiteboard system comprising a platform backend operably coupled to a platform frontend operating on a client device, the platform backend configured to:
cause display of a graphical user interface of the virtual whiteboarding platform using the platform frontend executing on the client device, the virtual whiteboarding platform configured to receive concurrent inputs from each of multiple client devices, each executing a respective platform frontend, the graphical user interface comprising a shared editor region displayed on each respective graphical user interface of the respective platform frontend and configured to generate graphical objects in response to inputs received from the multiple client devices;
cause display of an issue-based graphical object in the shared editor region, the issue-based graphical object displaying data extracted from an issue object managed by the issue tracking platform and being a selectable graphical object to cause redirection to a corresponding issue view in a user interface of the issue tracking platform;
cause display of a set of attribute elements that can be applied to the shared editor region, the set of attribute elements comprising one or more issue attribute elements, each issue attribute element of the one or more issue attribute elements associated with an attribute that can be applied to the issue object at the issue tracking platform; and
in response to a user input, positioning an attribute element, from the set of attribute elements, on the issue-based graphical object and determining that the attribute element corresponds to an issue attribute element of the one or more issue attribute elements, causing the whiteboarding platform to access a gateway of the issue tracking platform and causing, via the gateway, a modification to the attribute of the issue object.

18. The virtual whiteboard system of claim 17, wherein:
in response to the user input applying the attribute element to the issue-based graphical object, the backend application causes display of the attribute element at a first location of the issue-based graphical object; and
in response to the issue object being updated at the issue tracking platform, the backend application stops the display of the attribute element at the first location.

19. The virtual whiteboard system of claim 18, further comprising, in response to the issue object being updated at the issue tracking platform, causing display of an update of the issue-based graphical object displayed in the shared editor region.

20. The virtual whiteboard system of claim 17, wherein, in response to the backend application receiving a change to the issue object from the issue tracking platform, cause the issue-based graphical object to be updated in accordance with the change to the issue object.
